(19) United States
(12) Patent Application Publication
(10) Pub. No.: US 2026/0220709 A1
(43) Pub. Date: Jul. 30, 2026

(54) REAL-TIME FINANCIAL INTELLIGENCE

(71) Applicant: Kamil Karbowiak, Warsaw (PL)

(72) Inventor: Kamil Karbowiak, Warsaw (PL)

(21) Appl. No.: 19/039,074

(22) Filed: Jan. 28, 2025

(51) Int. Cl. G06Q 40/06; G06N 20/00

(52) U.S. Cl. CPC G06Q 40/06; G06N 20/00

(57) ABSTRACT

At least one example describes mechanisms for real-time financial intelligence (RFI) that leverage one or more machine-learning (ML) techniques to process financial data. In at least one example, RFI may dynamically generate dimensions and their associated contextual information within the financial data to enable dimensional intelligence. In at least one example, dimensional intelligence may include performing intelligent data analytics across the dimensions, enabling generation of meaningful insights, efficient reporting, identifying patterns, and supporting decision-making. In at least one example, RFI may offer an interactive graphical user interface-financial intelligent chat (Fine-Chat), enabling users to input financial queries in a natural language format. In at least one example, via these financial queries, Fine-Chat may perform dimensional intelligence, dimensional analysis, intelligent data analytics and generates real-time financial reports, financial recommendations. Fine-Chat may generate a response to a financial query including at least one result in a natural language format.

### BACKGROUND

In financial management, traditional methods such as Microsoft Excel® and spreadsheets often involve slow, error-prone processes that hinder businesses from obtaining timely insights. These conventional approaches typically rely on human interpretation and are limited in their ability to analyze large datasets in real time. As a result, decision-makers may struggle to generate actionable insights or receive proactive suggestions based on emerging financial trends. The lack of dynamic, data-driven feedback can lead to missed opportunities or delayed responses to market changes, impacting the agility and growth of the business. Additionally, traditional static financial reports may lack the flexibility to adapt to real-time changes, leading to the generation of new reports each time adjustments are made, which may further contribute to delays. The time-consuming nature of these tasks can divert attention from higher-value activities, reducing overall efficiency. The reliance on manual aggregation and static reporting can result in inaccuracies, inconsistencies and prevent businesses from making timely, informed decisions that drive growth or improve efficiency.

### SUMMARY

Described herein are one or more mechanisms for real-time financial intelligence (RFI) that leverage one or more machine-learning techniques for processing financial data associated with a business entity. In at least one example, the one or more mechanisms for the RFI may include accessing financial data of the business entity from a financial database. The financial data may include a plurality of structured financial records, comprising account information associated with a transaction. For example, the account information may include, but is not limited to, account name, account number, date of creation, account type (such as asset, revenue, liability, expense), account category (e.g., income statement or balance sheet) etc. In at least one example, the structured financial data may include chart of accounts (COA) representing an organized list of all the financial accounts in a general ledger (G/L) of the business entity.

In at least one example, the real-time financial intelligence includes dimensional intelligence. A dimension of a set of dimensions may correspond to a distinct (categorization) attribute for segmenting, analyzing, processing and reporting the financial data. Dimensional intelligence may include analysis of the financial data across multiple dimensions, enabling generation of meaningful insights, identifying patterns, and supporting decision-making. In at least one example, the set of dimensions may be generated dynamically based at least in part on the financial data. The dimensions may be generated by deploying one or more machine-learning techniques that are configured to identify associations between the dimension and a set of relevant structured financial records.

In at least one example, the generated dimension may be mapped automatically to a set of dimensional values by retrieving the set of relevant structured financial records. In at least one example, mapping may be performed dynamically by deploying the machine-learning techniques to automatically assign the set of dimensional values (such as assigning Europe and Germany to a country dimension) based on patterns or metadata in the set of relevant structured financial records. Alternatively, static mapping may be applied, where predefined or fixed rules may be used to assign dimensional values to the dimension on specific attributes, such as account names or categories (e.g., account name as, Sales Revenue-Europe).

In at least one example, a dimensional context associated with each dimension of the set of dimensions may be generated dynamically by applying the one or more machine-learning techniques. In at least one example, the dimensional context corresponds to an interpretation of the dimension in a natural language format. In at least one example, the dimensional context defines a semantic meaning of the dimension, its relevance to the set of dimensional values, and an influence of the dimension on processing of the financial data. In at least one example, the one or more machine-learning techniques leverage a first large language model (LLM) to generate the dimensional context for each dimension. Once the associated set of dimensional values and the corresponding dimensional context is generated for each dimension, financial queries may be received and processed.

In at least one example, the real-time financial intelligence may provide an interactive graphical user interface (GUI)-financial intelligent chat (Fine-Chat) that enables users to input financial queries in a natural language format. In at least one example, via these financial queries, Fine-Chat performs dimensional intelligence, intelligent data analytics and generates real-time financial reports, financial recommendations or advice. In at least one example, a financial query may be received in the natural language format via an interactive user interface. In at least one example, the financial query may comprise at least one intent to be performed on the financial data based on one or more dimensions of the set of dimensions. In at least one example, an intent corresponds to an action (e.g., “show,” “provide,” “compare”).

In at least one example, one or more financial reports may be generated dynamically in response to the financial query. Once the financial query is received, the disclosed one or more mechanisms may perform a query interpretation to identify intents and data entities (e.g., dimensions and/or financial metrics such as revenue, or cost) within the financial query. Following the query interpretation, a query analysis may be conducted, involving mapping the identified data elements—such as data entities and/or intent to relevant financial data (e.g., the dimensional values) by retrieving the financial database. The query analysis may further comprise contextual analysis configured to analyze a context of the financial query (e.g., whether the financial query is a follow-up query) and the dimensional contexts of the one or more dimensions. Based on the contextual analysis, the data aggregation may be performed including the data analytics (e.g., calculating financial metrics) and aggregating the relevant financial data in accordance with financial query.

In at least one example, a generated financial report of the one or more financial reports corresponds to an identified dimension derived from the financial query. The financial report may be a structured document that presents the relevant financial data from the financial query (e.g., the identified dimensions and their associated dimensional values), organized (e.g., displayed as columns) alongside the calculated one or more financial metrics (e.g., displayed as rows). In at least one example, the one or more financial metrics are identified from the financial query. In at least one example, the one or more financial metrics are identified from past business practices. In at least one example, a formatted response may be generated in the natural language format based at least in part on the financial report, the dimensional context and the financial query. The formatted response may include at least one result that corresponds to the at least one intent from the financial query by deploying a second large language model. In at least one example, the at least one result includes the data analytics associated with the one or more financial metrics, reflecting the dimensional values of the identified dimension.

In at least one example, subsequent to the financial query, a contextual query may be received in the natural language format, including at least one intent and one or more parameters. A parameter of the one or more parameters is based at least in part on the one or more dimensions or the at least one result. The contextual query may be built upon or expand the context of the previous financial query, typically retrieving more specific details or performing additional analysis based on earlier results. In at least one example, a response may be generated based on the contextual query by deploying the second large language model (LLM) of the one or more machine-learning techniques. In at least one example, the at least one intent corresponds to a request for a financial recommendation. In at least one example, the generated response includes a result comprising the financial recommendation in the natural language format.

In at least one example, a first subset of financial data may be extracted from the financial data based on a first dimension of the set of dimensions. In at least one example, the first dimension corresponds to a customer attribute of the financial data. By applying the one or more machine-learning techniques, behavior patterns-including regular and anomalous behaviors—may be identified from the first subset of financial data. In at least one example, the one or more machine-learning techniques are trained on historical behavior patterns from previous interactions or transactions associated with the first dimension. In at least one example, a churn probability may be predicted for each structured financial record of the first subset of financial data based on the identified behavior patterns. In at least one example, the first subset of financial data may be categorized into a set of segments based on the predicted churn probability (e.g., including various churn probability segments such as very low, low, medium, high, and very high).

Similarly, in at least one example, the first subset of financial data may be categorized into another set of segments based on the identified behavior patterns (e.g., customers that are not active, anomalies, frequent buyers). In at least one example, an interactive graphical user interface may be provided that includes one or more visual representations (e.g., a pie chart, bar graph, line graph, tabular form) associated with the set of segments. In at least one example, the interactive graphical user interface (GUI) displays a segment context in the natural language format. For example, for a segment “CLV,” the segment context may comprise, “CLV stands for customer lifetime value. It is a metric used to estimate the total revenue a business can expect from a single customer over the duration of their relationship with the company”. In at least one example, the interactive GUI may display the data analytics (e.g., total customers, total expenses, expected purchases, frequency of the purchase, rating, loyalty, segment name etc.) associated with a segment of the set of segments.

In at least one example, a second subset of financial data may be extracted from the financial data based on a second dimension of the set of dimensions. In at least one example, the second dimension corresponds to an item, product or a service attribute of the financial data. The second subset of financial data may be analyzed by applying the one or more machine-learning techniques that are configured to perform the data analytics and predictive analytics. In at least one example, the second subset of financial data may be segmented into one or more segments (e.g., obsolete products, performing items etc.) based on the data analytics including sales patterns. Similarly, the second subset of financial data may be segmented using predictive analytics that may leverage data analytics to forecast potential actions for the second subset of financial data, such as identifying items or services requiring specific tactics (e.g., time to promote, products that need clearing out, or items with sales potential). In at least one example, an interactive graphical user interface may be provided, including one or more visual representations associated with the one or more segments. The interactive graphical user interface may display a segment context and the data analytics (e.g., a count value) associated with a segment of the one or more segments.

In at least one example, a specific entity may be selected from a set of entities within a defined dimensional value of the set of dimensional values. For instance, within the item dimension, a dimensional value may include “electronic accessories,” which may encompass a set of entities such as Bluetooth devices, headphones, and other related items. A brief marketing message (e.g., a one- or two-liner) may then be generated for the selected entity based on its attributes. By leveraging a third large language model within the machine-learning techniques, a contextually relevant marketing message in natural language may be created, providing valuable assistance in generating tailored content. In at least one example, it may be appreciated that the first, second, and third LLMs may refer to the same LLM or to different LLMs.

In at least one example, a system is provided that includes one or more data processors and a non-transitory computer readable storage medium containing instructions which, when executed on the one or more data processors, cause the one or more data processors to perform part or all of one or more methods disclosed herein.

In at least one example, a computer-program product tangibly embodied in a non-transitory machine-readable storage medium, including instructions configured to cause one or more data processors to perform part or all of one or more methods or processes disclosed herein.

In at least one example, a system is provided that includes one or more means to perform part or all of one or more methods or processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

### BRIEF DESCRIPTION OF DRAWINGS

The examples will be understood more fully from the detailed description given below and from the accompanying drawings, which, however, should not be taken to limit the disclosure to the specific examples, but are for explanation and understanding only.

FIG. 1 is a schematic to perform real-time financial intelligence (RFI), in accordance with at least one example.

FIG. 2 is a schematic including generation of dimensions, in accordance with at least one example.

FIG. 3A is a screenshot including a user interface for the dimensions, in accordance with at least one example.

FIG. 3B is a screenshot including a user interface for dimensional contexts, in accordance with at least one example.

FIG. 3C is a screenshot including a user interface for a dimensional analysis, in accordance with at least one example.

FIG. 4 is a schematic including processing of a financial query for the real-time financial intelligence, in accordance with at least one example.

FIG. 5A is a screenshot of a user interface enabling financial intelligent chat (Fine-Chat), in accordance with at least one example.

FIG. 5B is a screenshot of an extended user interface of Fine-Chat, in accordance with at least one example.

FIG. 6 illustrates a flowchart for performing real-time financial intelligence, in accordance with at least one example.

FIG. 7A is a screenshot of a user interface providing intelligent data analytics for a first dimension, in accordance with at least one example.

FIG. 7B is a screenshot of an extended user interface providing intelligent data analytics, in accordance with at least one example.

FIG. 7C is a screenshot displaying a user interface for interacting with Fine-Chat (financial intelligent chat), in accordance with at least one example.

FIG. 8A is a screenshot of a user interface providing intelligent data analytics for a second dimension via Fine-Chat, in accordance with at least one example.

FIG. 8B is a screenshot of a user interface enabling Fine-Chat for contextual querying, in accordance with at least one example.

FIG. 9A is a screenshot displaying a user interface providing the intelligent data analytics for the second dimension, in accordance with at least one example.

FIG. 9B is a screenshot displaying an extended user interface (UI) for a segment associated with the second dimension from FIG. 9A, in accordance with at least one example.

FIG. 9C is a screenshot displaying another extended user interface (UI) providing details for a specific entity from the FIG. 9B, in accordance with at least one example.

FIG. 10A is a screenshot displaying a user interface of Fine-Chat for providing financial advice or recommendations, in accordance with at least one example.

FIG. 10B is a screenshot displaying a user interface of Fine-Chat for the contextual querying of the financial advice or recommendations, in accordance with at least one example.

FIG. 10C is a screenshot of a user interface for a response evaluation, in accordance with at least one example.

FIG. 11 is a schematic of an environment for integration of the disclosed real-time financial intelligence with a cloud, in accordance with at least one example.

FIG. 12 is a schematic of a cloud deployment model, in accordance with at least one example.

FIG. 13 is a schematic of a computing device that performs real-time financial intelligence, in accordance with at least one example.

### DETAILED DESCRIPTION

At least one example is directed, in part, to real-time financial intelligence (RFI) that leverages one or more machine-learning (ML) techniques to process financial data associated with a business entity. Financial data may include a plurality of structured financial records, comprising account information e.g., account name, account number, date of creation, account type, account category, etc. In at least one example, structured financial data may include chart of accounts (COA) representing an organized list of all financial accounts in a general ledger (G/L) of business entity. In at least one example, real-time financial intelligence may dynamically generate dimensions and their associated dimensional contexts to enable dimensional intelligence. In at least one example, a dimension may refer to a specific aspect or attribute of financial data that can be used to categorize or segment financial data to perform data analytics. For example, typical dimensions in financial data may include time, department, geography, project type, item, customer etc. In at least one example, dimensional intelligence may include performing intelligent data analytics across dimensions, enabling generation of meaningful insights, efficient reporting, identifying patterns, and supporting decision-making.

In at least one example, RFI may offer an interactive graphical user interface (GUI)-financial intelligent chat (Fine-Chat) that enables users to input financial queries in a natural language format. In at least one example, via these financial queries, Fine-Chat may perform dimensional intelligence, dimensional analysis, intelligent data analytics and generates real-time financial reports, financial recommendations or advice. In at least one example, a financial query may comprise data elements such as at least one intent (e.g., an action to perform), one or more dimensions (e.g., time, region, customer, items), and financial metrics (e.g., revenue and sales). In at least one example, Fine-Chat may generate a response to a financial query including at least one result that corresponds to at least one intent in a natural language format.

In at least one example, generated response is formatted to enhance readability and clarity, such as by presenting results in new paragraphs, using bold for emphasis, or organizing information into structured sections to provide a coherent and user-friendly output. In at least one example, Fine-Chat supports contextual queries where intent of a query may depend on generated response to a previous financial query or another intent within same contextual query. In at least one example, RFI mechanisms include an interactive interface that enables users to evaluate generated responses or financial reports by drilling down into specific financial metrics (or numbers) and tracing them back to underlying transaction records for enhanced transparency and accuracy.

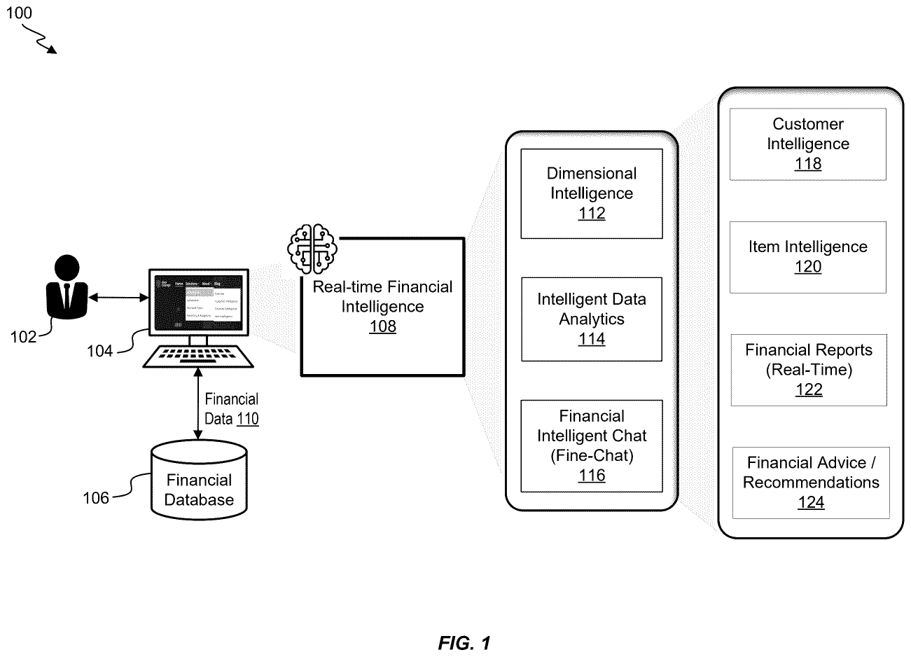

FIG. 1 is a schematic to perform real-time financial intelligence (RFI) 108, in accordance with at least one example. Techniques or mechanisms, as disclosed herein, may enable users 102 to perform real-time financial intelligence via a computing device 104. In at least one example, real-time financial intelligence (RFI) 108 may provide dimensional intelligence 112 and intelligent data analytics 114 by accessing (or processing) financial data 110 from a financial database 106. A dimension may refer to a specific aspect or attribute of financial data 110 that can be used to categorize or segment financial data 110 to perform data analytics. Typical examples of dimensions within financial data 110 may include, but are not limited to, time (e.g., months, quarters), geography (e.g., regions, countries), product or item categories (e.g., electronics, clothing), or customer segments (e.g., age groups, purchase behavior).

Dimensional intelligence 112 refers to application of analytical techniques (or data analytics) that leverage these dimensions to provide deeper insights into financial data 110. By analyzing financial data 110 across multiple dimensions, dimensional intelligence 112 may enable identification of patterns, correlations, and trends that may not be apparent from a single perspective. Dimensional intelligence 112 may involve dynamic generation of categories for efficient reporting, filtering and analysis. For example, financial data 110 may be grouped and examined based on dimensions such as customers, regions, and products, enabling detailed insights and reports. By leveraging dimensional intelligence 112, business entities may extract actionable insights, make data-driven decisions, and generate accurate forecasts by analyzing financial data 110 across multiple dimensions.

In at least one example, dimensional intelligence 112 may incorporate a dimensional analysis using natural language prompts (e.g., independent or follow-up queries) to examine financial data 110 by analyzing individual or combined dimensions. Rather than manually transforming financial data 110 to display specific aggregations or summarizations, such as arranging fields, applying filters, sorting, or pivoting, dimensional analysis may enable these tasks through natural language prompts e.g., “sort on item categories from smallest to largest” or “show average cost per category.” Dimensional analysis may leverage artificial intelligence (AI) such as large language models and data analytics to suggest layouts in analysis interface, thereby streamlining process.

In at least one example, dimensional intelligence 112 may include a more granular analysis across multiple dimensions, such as a first dimension and a second dimension. For instance, first dimension, corresponding to customer intelligence 118, and second dimension, corresponding to item (or services) intelligence 120, may form a subset of dimensional intelligence 112. This granular analysis may enable deeper insights into customer behavior and product performance, facilitating more targeted decision-making and enhanced business strategies. For example, understanding which products are popular in specific regions or which customer segments are most profitable.

In at least one example, disclosed real-time financial intelligence 108 may provide an interactive user interface-financial intelligent chat (Fine-Chat) 116 that enable users 102 to input financial queries in a natural language format. In at least one example, real-time financial intelligence 108, including dimensional intelligence and intelligent data analytics, may be performed via Fine-Chat. Once dimensions are generated, Fine-Chat 116 may provide a conversational interface for interacting with real-time financial intelligence solution 108 by input financial queries. In response to these prompts or financial queries, RFI solution 108 may perform intelligent data analytics 114 that encompasses tools and methods used to gather, analyze, and visualize financial data 110. Based at least in part on intelligent data analytics 114 and financial queries, in at least one example, RFI 108 may generate financial reports 122 in real-time. Business entities may utilize these dynamic financial reports 122 to monitor their financial health in real-time and make strategic decisions. These reports may be customized through financial queries that incorporate dimensions, offering a targeted view of performance. Additionally, in at least one example, disclosed RFI 108 may generate responses based on natural language prompts (or financial queries), including explanations, insights, and recommendations 124 on tasks in a conversational format.

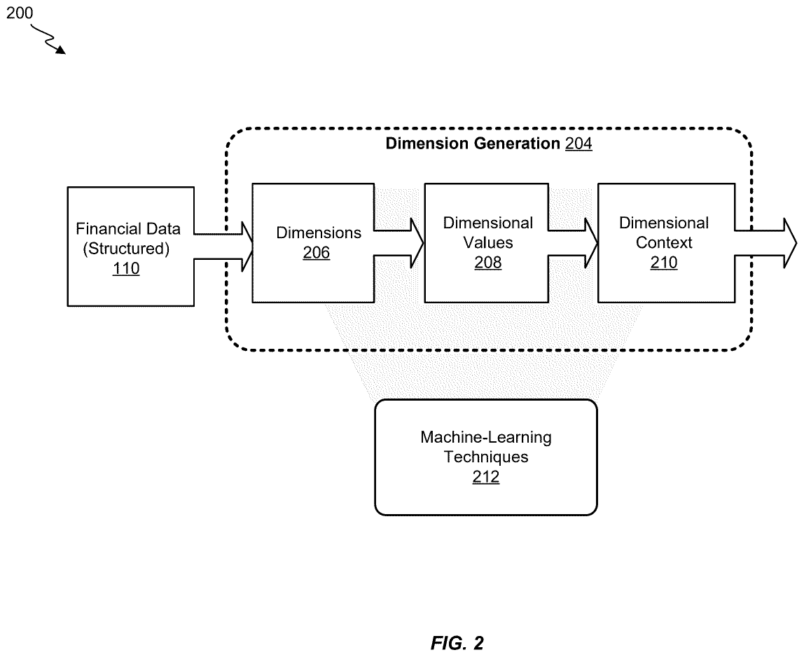

FIG. 2 is a schematic 200 including dimension generation 204, in accordance with at least one example. Dimensions 206 may serve as axes or filters through which financial data 110 can be broken down, enabling multi-dimensional analysis. For example, by using time dimension, an organization can track performance over periods, while department dimension may help assess financial results by specific business units. For processing financial data 110 based on dimensions 206, financial data 110 may be structured or organized in a predefined manner, typically stored in a tabular or relational format in financial database 106.

In at least one example, structured financial data 110 may include chart of accounts (COA) representing an organized list of all financial accounts in a general ledger (G/L) of a business entity. COA serves as an organizational tool, categorizing and lining up all transactions, including items such as products or services, customer-related information, revenue, expenses, and other financial activities that business entity conducts during a specific accounting period. For creating COA, financial data 110 may be collected from various sources and then processed into structured financial data. For integration with external systems e.g., financial software or cloud services that store relevant data, application programming interfaces (APIs) can be utilized. These APIs enable seamless integration and data retrieval within various data sources.

In at least one example, COA may be categorized into assets, liabilities, equity, revenues, and expenses, with each account assigned a unique code and description to facilitate systematic recording, tracking, and reporting of financial transactions. In at least one example, financial data 110 (or COA) may be filtered based on dimensions. For example, customer and item data may be linked to specific accounts within COA, such as revenue accounts for sales income, accounts receivable for amounts owed by customers, and cost of goods sold (COGS) for item-related expenses. These associations within financial data may enable extraction of targeted financial data tied to a specific dimension e.g., customer and item performance. COA serves as backbone of financial record-keeping, providing consistency, accuracy, and clarity in financial analysis.

In at least one example, dimensions 206 may be configured as predefined categories that are assigned to relevant financial accounts, during, or subsequent to creation of accounts, within disclosed RFI tool 108. For example, when setting up chart of accounts, certain dimensions, such as items, customer, or area, may be predefined or manually added, which may be linked to relevant accounts. As an illustrative example, during or prior to creation of a G/L account, a predefined dimension named, “Country” may be assigned with specified dimensional values—such as USA, Canada, and UK. By assigning “Country” dimension to G/L account, each financial transaction involving G/L account may be automatically categorized by country. Dimension generation 204 may enable more detailed financial analysis and reporting, as transactions can be analyzed not just at account level but also across specific country-based groupings. Additionally, dimension-based categorization may facilitate artificial intelligence (AI)-driven analytics, enabling business entities to analyze financial performance and trends by dimension to filter, group, and aggregate financial data.

In at least one example, RFI 108 includes automatic (or dynamic) generation of one or more dimensions, such as “Department,” by analyzing characteristics of structured financial data (e.g., chart of accounts) and/or applying predefined business rules. When setting up a chart of accounts, account types, categories, and metadata associated with each account are examined to identify relevant dimensions that correspond to distinct attributes of financial data. For example, a revenue account may be linked to a customer dimension to represent which customers are generating specific revenue streams, while an equity account might be associated with an organizational unit (e.g., a department) to reflect allocation of equity within that department.

To enhance this process, one or more machine-learning (ML) techniques 212 may be deployed to automatically identify dimensions 206 by analyzing structured financial data 110 (e.g., chart of accounts) associated with business entity. One or more ML techniques may be initially trained on historical financial data from similar businesses, where data is labeled with corresponding dimensions such as “Revenue,” “Product,” or “Region.” During training phase, machine-learning models may learn patterns and relationships between account information, associated metadata, and their relevant dimensions. As part of this training, natural language processing (NLP) techniques, such as word embeddings (e.g., word2vec or BERT), may be leveraged to address variations in terminology across different organizations. For example, term “Revenue” may be referred to as “Income” in financial data of another business entity. NLP techniques map semantically similar terms to a continuous vector space, enabling model to handle synonyms and identify dimensions accurately, regardless of specific terminology used in financial records. Once trained, one or more ML techniques may be capable of recognizing and associating dimensions with financial data for new, unlabeled records. Semantic mapping provided by NLP techniques enables automatic generation of dimensions that are contextually relevant and aligned with structure and attributes of financial data for a specific business entity.

Once synonym mapping is completed, structured financial data 110 can be mapped to dimensions using trained machine-learning techniques 212. Patterns learned during training phase help ML techniques 212 to classify or assign appropriate dimensions to each account or transaction. For example, “Sales” accounts may be classified under “Department” dimension. Additionally, triggers or conditions may dynamically assign relevant dimensions to financial accounts. For instance, if an account involves international sales or services, model may automatically assign “Country” dimension.

In at least one example, dimension generation 204 may further involve populating or mapping these dimensions to corresponding dimensional values. For instance, a “Country” dimension may be mapped to specific values such as “USA,” “UK,” or “Canada,” depending on region associated with a particular financial transaction. Mapping process for assigning values to identified dimensions may include two approaches: dynamic mapping and static mapping. In dynamic mapping, machine-learning techniques 212 may be deployed to analyze relevant structured financial records, such as chart of accounts (COA), to identify patterns or metadata that can automatically assign dimensional values to a given dimension. For example, when generating (or assigning) a “Country” dimension in COA, instead of assigning fixed dimensional values, model looks at financial data or metadata linked to specific accounts to identify patterns or contextual clues that indicate which country transaction is associated with. If, for example, it is detected that transactions under “Sales Revenue” account comprise metadata such as “USA,” “Germany,” or “France,” it dynamically maps these values (such as “USA” and “Germany”) to “Country” dimension.

Alternatively, static mapping may be applied, where predefined or fixed rules may be used to assign dimensional values to dimensions based on specific attributes. For example, an account category such as, “Sales Revenue-USA” may be statically mapped to “Country” dimension with an associated dimensional value of “USA.” Static mapping is predetermined based on business-specific rules or conventions that assign certain values to dimensions in a consistent manner.

In at least one example, a dimensional context 210 may be generated for each dimension of one or more dimensions by applying one or more machine-learning techniques 212 that include a large language model (LLM). Dimensional context 210 may correspond to a human-readable interpretation of each dimension, which involves defining semantic meaning of dimension, its relevance to financial data, and its influence on processing of that financial data. This dimensional context 210 may provide valuable insights into how dimensions such as “Country,” “Department,” or “Project” may impact financial transactions, decision-making, reporting and analysis.

In at least one example, one or more LLMs may be leveraged to generate dimensional context 210 for each dimension within financial data 110. A large language model (LLM) may utilize advanced natural language processing (NLP) techniques, often based on transformer architectures such as GPT (generative pre-trained transformer). LLM may be trained on large datasets that may include both structured and unstructured financial data, enabling it to understand relationships between various data elements. When tasked with generating dimensional context 210, LLM may first analyze input data—such as dimension name (e.g., “Department”) and its associated values (e.g., “Administration,” “Marketing.” “Sales”)—to identify semantic role of each dimension in context of broader data structure.

LLM may use its learned knowledge of underlying relationships within financial data 110 to generate human-readable descriptions. This may involve recognizing how each dimension fits within an organizational or financial context. Specifically, LLM may apply pattern recognition and context prediction algorithms to generate a narrative that explains a relevance of dimension to business analysis, such as how “Department” dimension influences financial performance across different business units (e.g., “Sales” contributing to revenue, “Operations” impacting cost efficiency). LLM may transform dimensions 206 and associated dimensional values 208 into embedding, which are vector representations of words and their contextual meanings, to produce more precise and relevant descriptions. LLM may also utilize attention mechanisms to weigh significance of each dimensional value and incorporate domain-specific knowledge about organizational structures, business operations, and financial metrics. Furthermore, LLM may generate context dynamically based on configuration and requirements of task, adapting its output based on dimension role and structure of financial data 110. By outputting these descriptions, LLM may assist in transforming raw dimensions into understandable and actionable insights for decision-makers.

In at least one example, LLM may generate dimensional context by interpreting dimension and its associated values in context of financial data. For example, for “Department” dimension, LLM may recognize that this dimension refers to functional areas of organization where business activities occur. LLM may then output a context description that highlights importance of this dimension in analyzing financial performance and resource allocation. Additionally, by understanding how different dimensional values—such as “Administration,” “Marketing,” or “Sales”—contribute to overall financial health, business entities can align their budgeting and planning strategies accordingly.

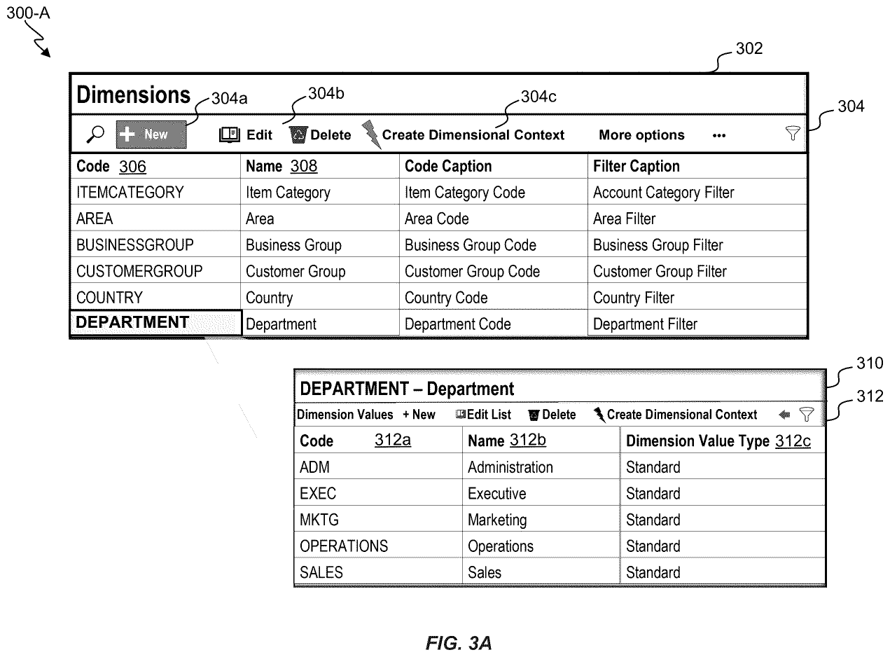

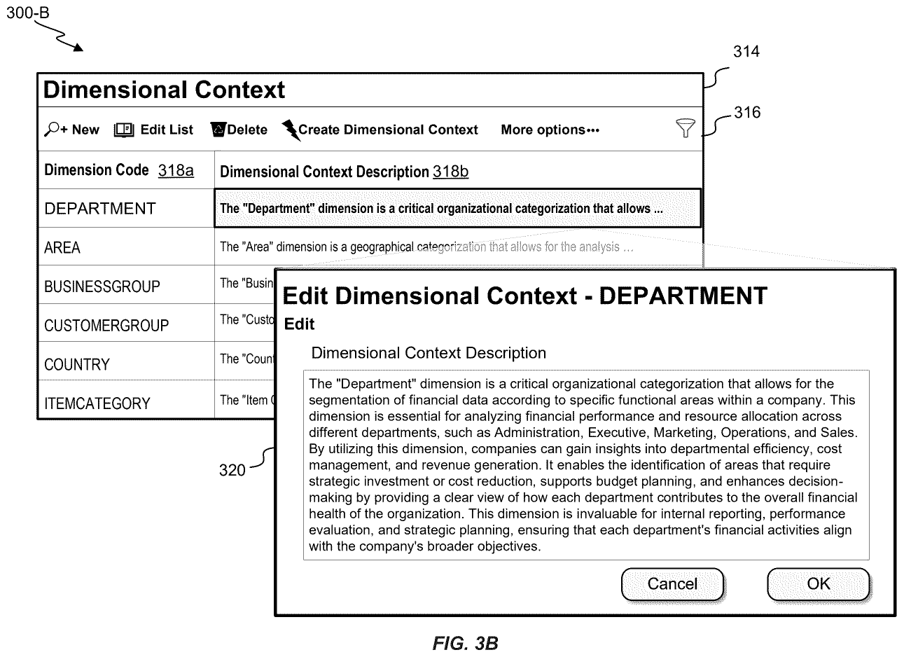

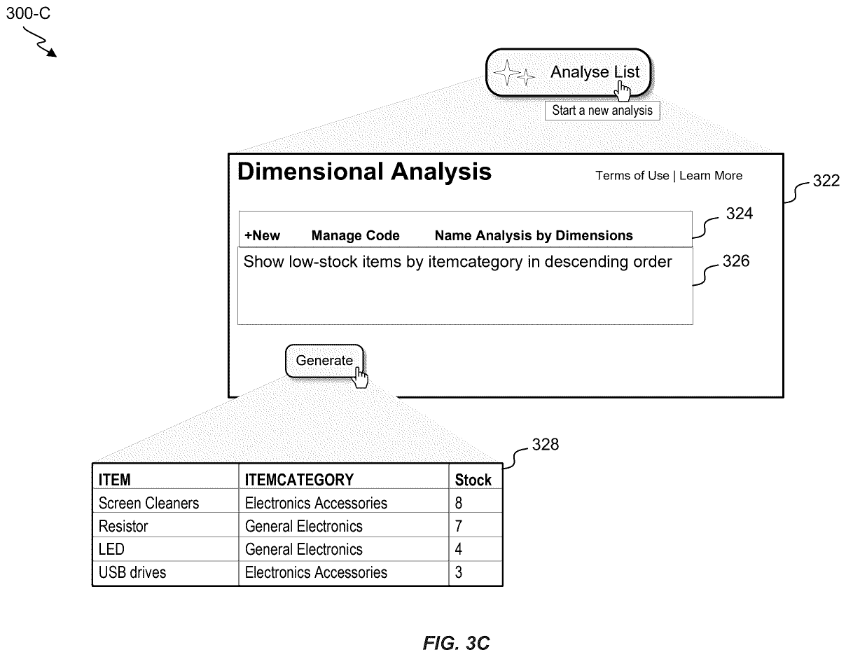

FIG. 3A is a screenshot 300-A including a user interface (UI) of dimensions 302, in accordance with at least one example. UI 302 may enable users to create, edit, and manage dimensions for subsequent intelligent data analytics 114, Fine-Chat 116, and financial reporting by using a toolbar 304. Toolbar 304 includes controls for (manually) creating a new dimension 304a, editing (or deleting) a dimension 304b, and creating dimensional context 304c. User interface 302 further includes a table comprising columns labeled “Code” 306, “Name” 308 etc. Example dimensions Codes such as “ITEMCATEGORY,” “BUSINESSGROUP,” “CUSTOMERGROUP,” “COUNTRY,” and “DEPARTMENT” are displayed alongside their respective captions and filter captions. This structure may facilitate organization and filtering of financial data based on various categorical dimensions, thereby improving data management and retrieval processes. Dimensions shown in UI 302 may be dynamically generated, predefined, or manually added by user 102.

User interface 302 may also be expanded to show specific details related to dimensional values 208 in an extended graphical user interface (GUI) 310. Extended GUI 310 provides enhanced controls for managing dimensional values (e.g., add or modify) through a dimensional value toolbar 312, with options for automatic mapping or manual input. Extended GUI 310 may also include dimension codes 312a, corresponding dimension names 312b, and their associated value types 312c. For example, dimension “DEPARTMENT” includes codes and their associated values such as, “ADM” (Administration), “EXEC” (Executive), “MKTG” (Marketing), “OPERATIONS” (Operations), and “SALES” (Sales), all categorized under “Standard” dimension value type 318.

FIG. 3B is a screenshot 300-B including a graphical user interface (GUI) 314 for dimensional context, in accordance with at least one example. GUI 314 appears when “Create Dimensional Context” 304c is selected from dimensional user interface 302 of FIG. 3A. This interface may enable users to define and manage descriptions for specific dimensions, providing context for their organizational roles. GUI 314 may further include columns such as, “Dimension Codes” 318a and “Dimensional Context Description” 318b. Upon selecting “DEPARTMENT” dimension, an editable description is shown in a pop-up window 320. This description corresponds to dimensional context 210 that may be dynamically generated by leveraging disclosed techniques. Pop-up window 320 may include further controls to cancel or save changes to database.

In at least one example, dimensional intelligence 112 includes a dimensional analysis generating a matrix (or a financial report in tabular format), where columns represent identified dimensions and requested financial statistics, organized in an order defined by financial query. For instance, instead of manually filtering data or calculating values based on specific dimensions, user may input a query (or a prompt) such as, “Show low-stock items by item category in descending order.” RFI 108 may process this query, identifying relevant dimensions (in this example, “item category”), and arranges data into a structured tabular format, displaying item categories, their corresponding item codes, and stock levels. In at least one example, dimensional analysis may include a deeper analysis of a dimension or a combination of dimensions e.g., sales per area or more complex analysis involving multiple dimensions, e.g., sales per campaign per customer group per area.

FIG. 3C is a screenshot 300-C including a graphical user interface 322 for dimensional analysis, in accordance with at least one example. GUI 322 may include a prompt box 326, which may help user to create (or input) natural language prompts for a suggested layout of dimensional analysis. For example, prompts such as, “sort on quantity from smallest to largest” or “show average cost per category” to quickly arrange fields, specify filters, and pivot on fields. This feature may simplify analysis process, making it more accessible and efficient. Prompt may be created in prompt box 326, where corresponding results may be generated that shows a matrix 328 of item categories including entities (e.g., screen cleaners, resistors), corresponding dimensional values (e.g., electronics accessories, general electronics) and number of stocks in descending order.

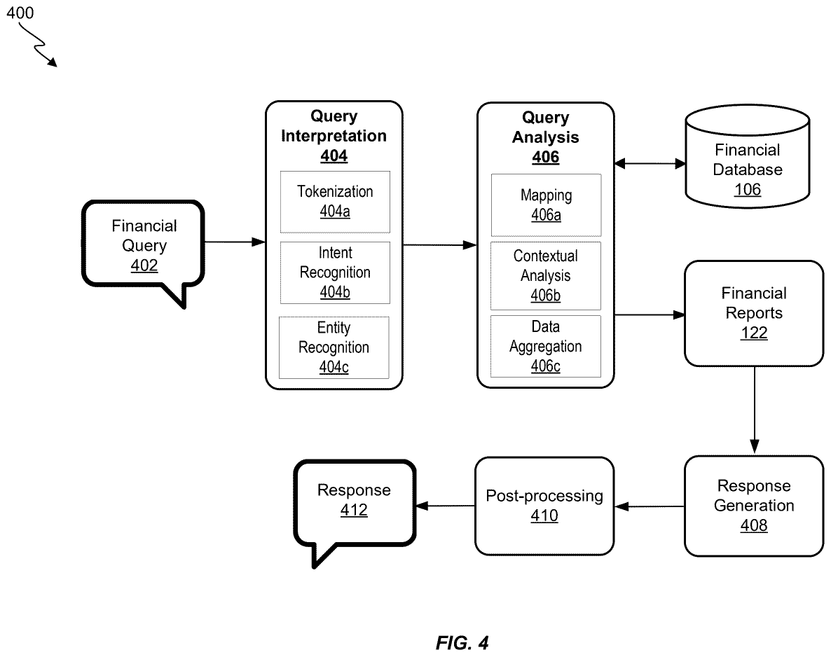

FIG. 4 is a schematic for processing a financial query 402 in a real-time financial intelligence (RFI) 108 tool, in accordance with at least one example. In at least one example, RFI 108 may be configured to process a financial query 402 related to financial data 110. In at least one example, disclosed techniques may generate relevant financial reports 122 (e.g., profit and loss (PNL) statements in real-time and responses in natural language format in response to financial query 402. For example, a financial query 402 may comprise, “compare revenues for Q1 2022 and Q2 2022” that may be received by an interactive user interface configured within financial intelligent chat (Fine-Chat) 116 handle financial queries 402 in natural language. Once financial query 402 is received, RFI 108 may perform query interpretation 404 by utilizing a large language model (LLM). In at least one example, LLM may help in converting financial query 402, written in natural language, into structured data that a machine can process. Query interpretation in LLM may include tokenization 404a, intent recognition 404b, and entity recognition 404c. Tokenization 404a may refer to a process of breaking down financial query 402 into smaller units called “tokens,” typically words or phrases. Each token may represent a meaningful component of input. In this illustrative example, financial prompt (or query) may be tokenized into following tokens: [“Compare,” “my,” “revenue,” “for,” “Q1 2022,” “and,” “Q2 2022”].

In at least one example, intent recognition 404b identifies one or more actions from financial query 402, such as comparing dimensions or time periods, or displaying insights. For example, in query “Compare my revenue for Q1 2022 and Q2 2022,” intent is to compare revenue between two time periods. In at least one example, entity recognition 404c involves identifying and classifying specific data entities or dimensions in financial query, such as dates, amounts, locations, product names, or financial metrics. In exemplary financial query, entities may include revenue (financial metric), Q1 2022 (time period), Q2 2022 (time period). Entity recognition 404c may help in understanding which data is relevant to user's request (e.g., “revenue,” “Q1 2022,” “Q2 2022”).

In at least one example, RFI 108 may perform query analysis 406 subsequent to query interpretation 404. In query analysis 406, mapping 406a may be performed in which recognized data elements e.g., data entities and/or intent and their associated semantic meanings may be mapped to relevant financial data by accessing financial database 106. For example, entities, “Q1 2022” and “Q2 2022” may be understood by LLM as referring to quarter 1 (e.g., January to March) and quarter 2 (e.g., April to June) and hence, may be mapped to time dimension within financial database 106. Similarly, recognized financial terms such as “revenue” may be mapped to financial metric that is calculated based on mapped dimensions included in financial query 402. Query analysis 406 may further include contextual analysis 406b and data aggregation 406c. In contextual analysis 406b, business context (or organization rules) may be interpreted by considering dimensional context 210 (human-understandable explanation of each dimension), business rules and previous queries (e.g., if query is a follow-up query). Contextual analysis 406b may enable refinement of data aggregation 406c process so that analysis is aligned with organizational standards so that correct dimensions and dimensional values are used for calculations.

In at least one example, data aggregation 406c follows, where financial data 110 may be retrieved from financial database 106 based on mapped dimensions and dimensional values 208. Dimensional values 208—such as specific time periods, departments, regions, or account categories—may be used in aggregation functions to calculate financial metrics (e.g., revenue). For example, when generating a profit and loss (PNL) report, mapped time dimension becomes a column, with dimensional values representing specific time periods (e.g., Q1 2022, Q2 2022). Intelligent data analytics 114 including calculations for each dimension (such as total revenue, expenses, net income, etc.) may be performed based on data retrieved from financial database 106 (e.g., chart of accounts), which may be structured to reflect dimensions 206 in financial data.

After data is aggregated, in at least one example, one or more financial reports, such as PNL reports may be generated in real-time, where mapped dimensions (e.g., time, region, department) from financial query 402 may be used as columns, and corresponding financial metrics (e.g., revenue, expenses, net income) may be shown as rows. Output of this process may be a structured financial report that reflects requested financial data, calculated and presented in accordance with recognized dimensions 206, dimensional values 208, and dimensional context 210, thereby supporting meaningful and accurate business decision-making. Through query analysis 406, raw financial data may be transformed into insightful, structured outputs that align with user's request or query, supporting effective decision-making.

In at least one example, a response generation 408 may be performed by incorporating financial reports 122 from query analysis 406, which reflect requested data aggregation 406c and contextual analysis 406b based on recognized data entities (e.g., “Q1 2022,” “Q2 2022”), mapped dimensions, and/or financial metrics (e.g., time, revenue). These financial reports 122 may contribute to response generation 408 process. In at least one example, LLM may convert financial reports 122, contextual information (e.g., query context and dimensional context), and recognized data elements from financial query 402 into a coherent, human-readable response 412. Generated response may include results corresponding to one or more intents identified in query. LLM operates by utilizing self-attention mechanisms, components of transformer-based models (such as GPT-3 or BERT) to understand relationships between tokens and synthesize relevant information. These models predict next word by considering context of entire input, focusing on different parts of query. For instance, phrase “Compare my revenue” will likely receive higher attention than less important words like “my” or “for,” as model identifies that key intent is to compare revenue. This contextual understanding enables LLM to prioritize elements of query, such as time periods (Q1 2022 vs. Q2 2022) and financial metric (revenue), enabling a more accurate and meaningful response.

In at least one example, LLM may perform post-processing 410 for formatting generated response to enhance clarity and presentation of generated response 412. Post-processing 410 may include generating summaries, applying logical flow, and formatting text for readability. Summary generation may leverage LLM's ability to produce concise versions of longer outputs, often using techniques such as extractive and abstractive summarization. For example, in response to a financial query for generating insights, LLM may summarize key insights into a brief format such as, “The revenue increased by $12,514,488.20, or 19.45%, from Q1 2022 to Q2 2022.” This generated response may enable users to quickly understand financial insights without having to sift through long text. Furthermore, in at least one example, LLM may perform formatting to generate (final) response 412 appropriately for easy consumption. For formatting, LLM may use template-based generation or learned patterns to structure output into clean, readable segments. Results may be formatted using bold text to emphasize key values, such as revenue figures and percentages, and structured into sentences, paragraphs, bullet points or numbered lists for clear separation of insights. LLM may apply these formatting techniques automatically during post-processing 410 so that response 412 adheres to presentation practices that are easy to interpret.

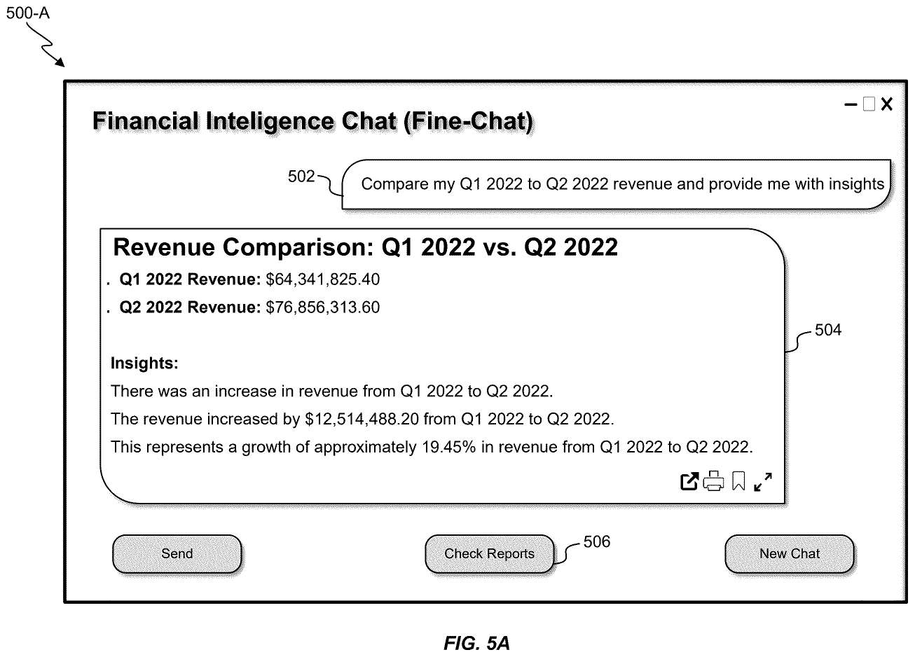

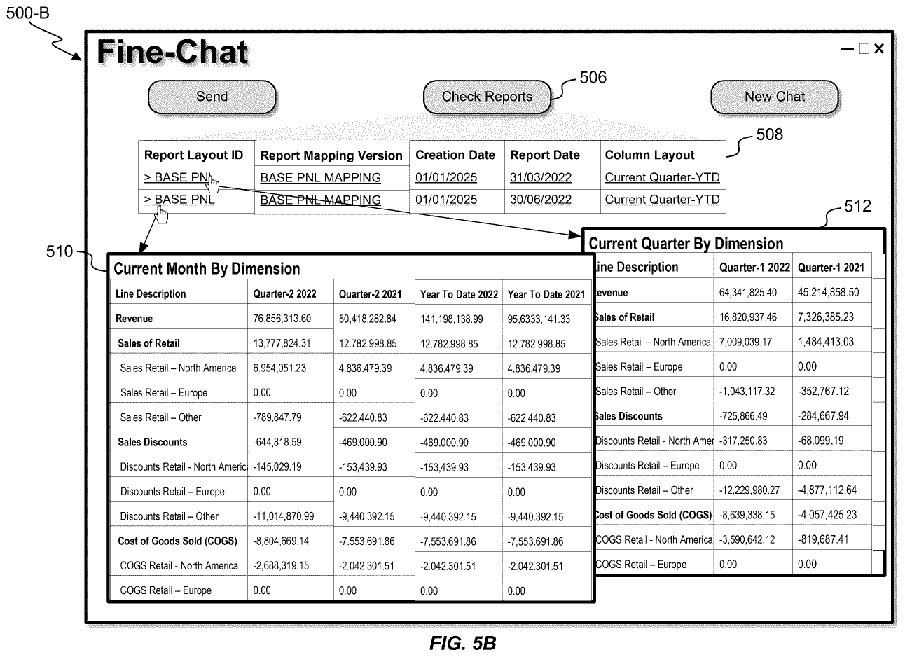

FIG. 5A is a screenshot of a user interface (UI) 500-A that enables financial intelligent chat (Fine-Chat) 116. UI 500-A is configured to facilitate dimension-based financial analysis by enabling users to input financial queries 402 and receive responses 412. In at least one example, Fine-Chat 116 is configured to process financial queries that include multiple intents, where a second intent of one or more identified intents is contingent upon result of a first intent. Specifically, execution or output of second intent may be dependent on outcome or data derived from first intent, thereby enabling a sequential or conditional flow of actions within query interpretation 404 process. In this example, user may input a financial query 502 in a textbox, such as asking Fine-Chat to compare revenue data for Q1 2022 to Q2 2022 and provide insights. LLM interprets query, recognizing a first intent to compare revenue figures for a time dimension including two time periods. Similarly, LLM may identify a second intent of providing insights regarding results of first intent. LLM processes time dimensions (Q1 2022 and Q2 2022) and understands their semantic context. In response, Fine-Chat 116 generates a response including two results, each corresponding to an intent. For example, a formatted response 504 may be generated including a first result presenting revenue figures for each quarter ($64,341,825.40 for Q1 2022 and $76,856,313.60 for Q2 2022), along with a second result including insights highlighting a revenue increase of approximately 19.45%.

Furthermore, LLM computes financial insights by accessing relevant financial data 122 and performing basic numerical calculations, such as determining percentage change between two quarters. insights are then expressed in a coherent and user-friendly manner, such as “The revenue increased by $12,514,488.20” and “This represents a growth of 19.45%.” UI 500-A may also offer additional interactive controls, such as options to start a new chat or to check reports 506 that were generated in response to query. This interaction helps users access information they need efficiently, with systems automatically interpreting query, analyzing financial data, and providing clear, actionable insights.

FIG. 5B is a screenshot of an extended user-interface 500-B, in accordance with at least one example. Extended UI 500-B is enabled by selecting “Check Reports” from Fine-Chat UI 500-A, where user may access dynamically generated one or more detailed financial reports in response to query 502. Specifically, a table 508 is created including two financial reports 510 and 512 based on selected query parameters, including dimensions such as time periods. Additionally, columns of table 508 include e.g., “Report Date” and “Column layouts (e.g., Current-YTD). For example, values in column “Report Date” corresponds to Q1 2022 (i.e., 3 months till March 2022) and Q2 2022 (next three months till June 2022). These values represent query interpretation 404 and query analysis 406 that are performed intelligently for subsequent generation of financial reports 122. Extended UI 500-B includes two financial reports each corresponding to a time dimension.

In at least one example, financial reports 122 may correspond to PNL reports that include a detailed break-down of financial metrics included in financial queries into further categories and subcategories. For example, a financial report (or table) 510 may include dimensions or financial metrics, such as revenue, which are part of financial query 502, along with detailed breakdown into subcategories, such as retail sales, sales discounts, costs, and expenses. Table 510 provides a comparison for quarter-2 of 2022 against quarter-2 of 2021, as well as Year-to-Date (YTD) metrics for 2022 (aggregating data from beginning of year to end of Q2 2022), along with a similar YTD comparison for 2021. Table 512 offers a parallel comparison for quarter-1 2022. These financial reports, such as 510 and 512, may deliver precise insights, including regional revenue contributions, operating expenses, cost breakdowns, and more, enabling users to identify emerging trends and make well-informed decisions. Dynamic nature of these reports maintains alignment with user's query, offering better customizable and targeted financial analytics to facilitate strategic decision-making.

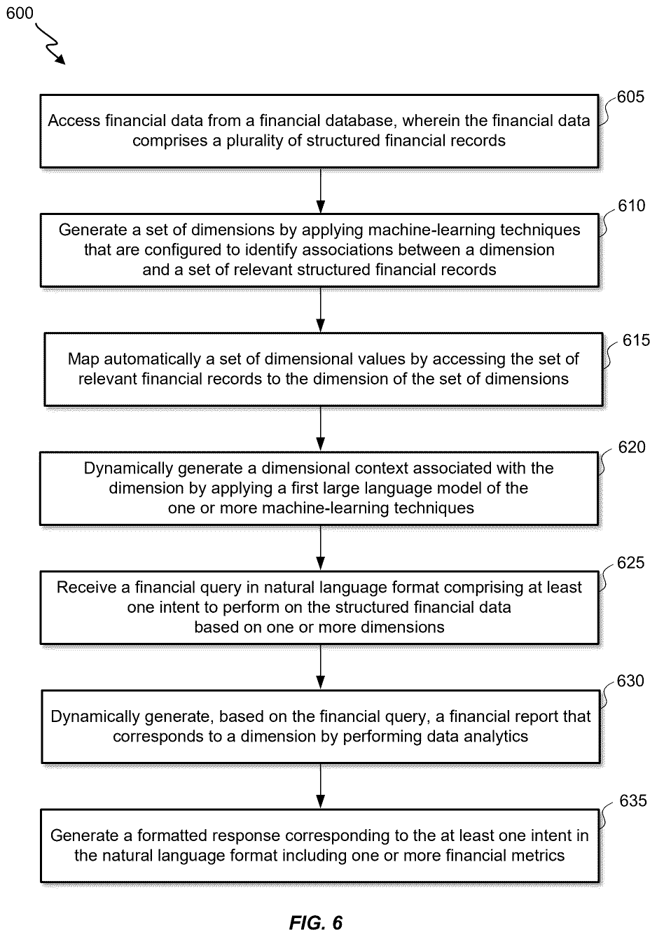

FIG. 6 illustrates a flowchart for performing real-time financial intelligence 108 that integrates dimensional intelligence 112, intelligent data analytics 114, and financial intelligent chat (Fine-Chat) 116, in accordance with at least one example. Blocks in flowchart are illustrated in a specific order, while order can be modified, for example, some blocks may be performed before others, and some blocks may be performed simultaneously. Blocks can be performed by hardware or software or a combination thereof. Process at block 605 may include accessing financial data 110 of a business entity from financial database 106, which may store a plurality of structured financial records. Each structured financial record may represent account information related to a specific transaction. At block 610, a set of dimensions 206 may be generated by applying one or more machine-learning techniques 212 that may identify associations between a dimension from set of dimensions 206 and a set of relevant structured financial records. Each dimension in set of dimensions 206 may correspond to a distinct (categorization) attribute for segmenting, analyzing, processing and reporting financial data 110 that may be linked to account information.

Dimensions 206 in financial data 110 may include time, department, geography, project type, item, customer etc. Process at block 615 may include automatically mapping a set of dimensional values 208 from relevant financial records within financial data 110 to corresponding dimensions in set of dimensions 206. Automatic mapping may be performed dynamically by applying one or more machine-learning techniques 212, which automatically assign dimensional values (e.g., mapping “Europe” and “Germany” to country dimension) based on patterns or metadata within relevant structured financial records. Alternatively, static mapping may be applied, where predefined rules are used to manually assign dimensional values to specific attributes, such as account names or categories (e.g., “Sales Revenue-Europe” for an account name). Process at block 620 may dynamically generate a dimensional context 210 corresponding to each dimension of set of dimensions 206 by applying one or more machine-learning techniques 212. These techniques 212 may leverage a first large language model (LLM) to interpret dimension in a natural language format, capturing its semantic meaning, relevance of dimensional values 208, and impact on processing financial data 110. Once dimensional values 208 and dimensional context 210 are generated, financial queries can be received and processed.

Process at block 625 may include receiving a financial query 402 in natural language format through an interactive user interface or Fine-Chat 116, which may include at least one intent specifying an action to be applied to financial data 110 based on one or more dimensions 206. A query interpretation 404 may identify intents and data entities (e.g., dimensions and/or financial metrics such as revenue, or cost) from financial query 402. After interpretation, a query analysis 406 may be performed, which includes mapping 406a, contextual analysis 406b (e.g., considering both dimensional contexts 210 of one or more dimensions 206 and query context, specifically for follow-up queries) and data aggregation 406c.

Processes at block 630 may dynamically generate a financial report 122 corresponding to an identified dimension of one or more dimensions by performing intelligent data analytics 114 in response to financial query 402. Financial report 122 may include one or more financial metrics derived from financial data 110 that is filtered and categorized based on an identified dimension and its associated set of dimensional values 208. Processes at block 635 may include generating, based at least in part on financial report 122, dimensional context 210, and financial query 402, a formatted response 412 including at least one result corresponding to at least one intent in natural language format. Generation of formatted response in real-time may be achieved by deploying a second large language model of one or more machine-learning techniques 212. Results from response may include intelligent data analytics 114 involving one or more financial metrics and identified one or more dimensions.

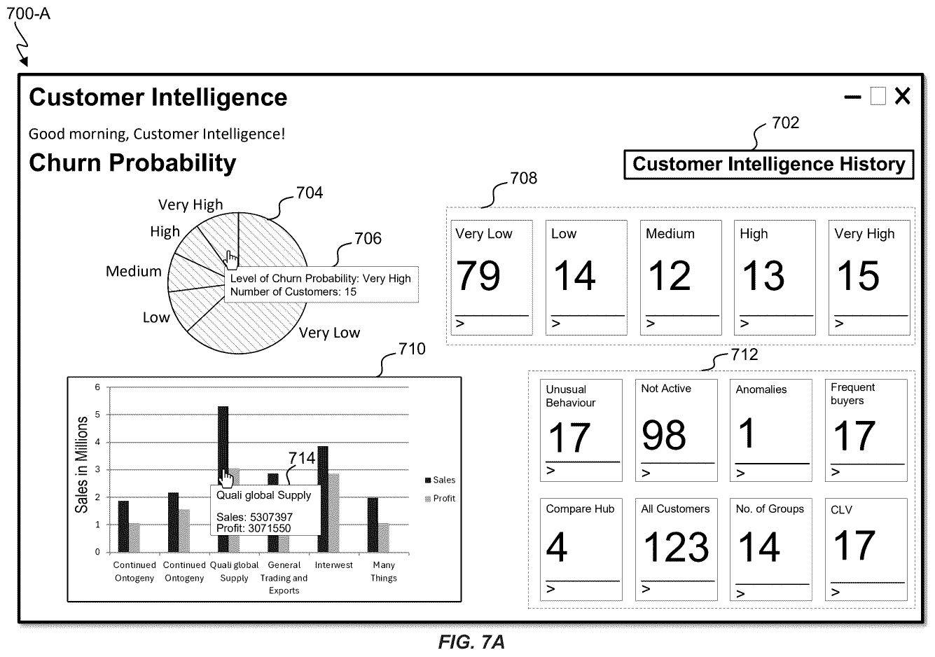

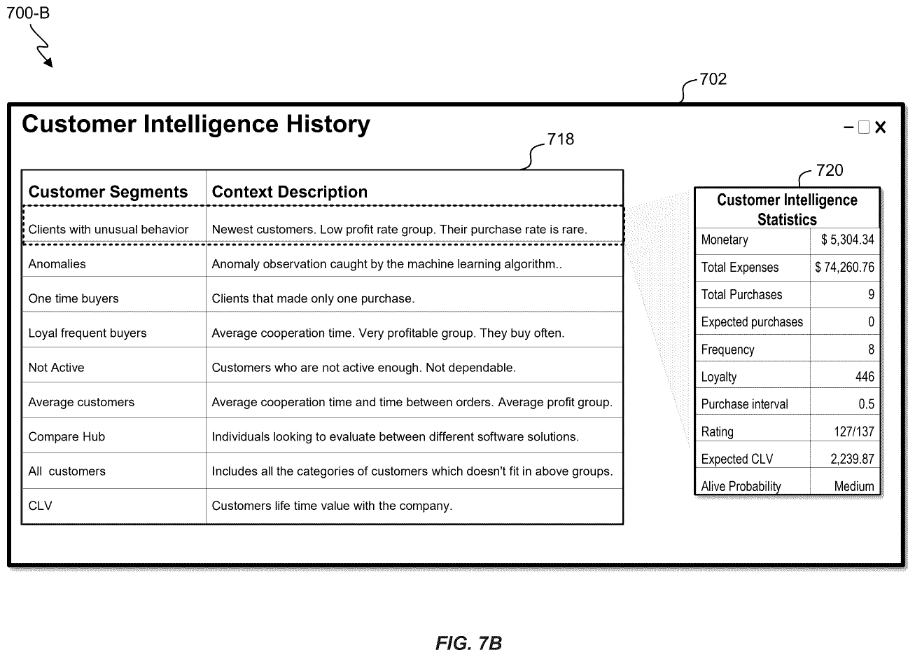

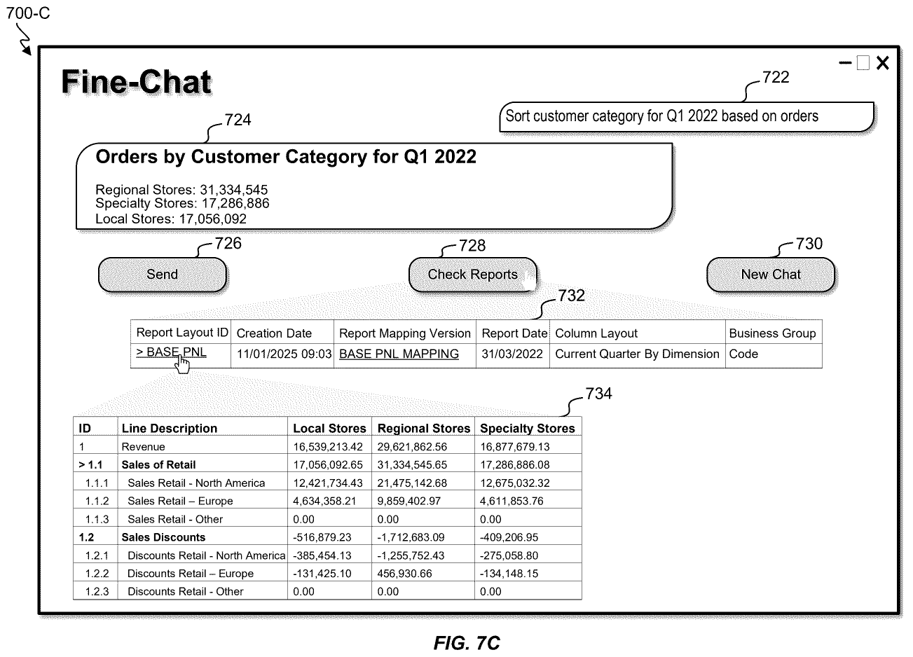

FIG. 7A is a screenshot of a user interface (UI) 700-A providing intelligent data analytics 114 for a first dimension, in accordance with at least one example. Dimensional intelligence 112 and intelligent data analytics 114 may be performed by leveraging one or more machine-learning techniques 212 to further categorize dimensions such as customers, items, and countries into distinct groups based on various behaviors and attributes. Categorization process may involve applying ML techniques 212 such as clustering, classification, and/or anomaly detection to identify patterns in financial data 110 and assigning them to relevant groups. In at least one example, RFI 108 may provide UI 700-A that includes intelligent data analytics 114 for customer category. To extract customer-related data, financial data 110 (e.g., chart of accounts (COA)) is analyzed, and accounts associated with customer transactions, such as revenue, receivables, and customer-specific fees, are linked to customer dimension. This enables system to perform customer intelligence by analyzing behavior patterns, spending trends, and profitability associated with different customer groups. In at least one example, disclosed RFI 108 tool incorporates dimensional intelligence 112 for customer category, providing a detailed and intelligent approach to categorizing and analyzing financial data 110 associated with customers.

In at least one example, anomaly detection or unusual behavior for customer dimension may be performed by identifying outliers using machine-learning techniques 212. Machine-learning techniques 212 may be configured to classify customers into different segments, such as frequent buyers, anomalous behavior, high-value customers, or at-risk customers, and customer lifetime value (CLV) based on patterns in their financial transactions. These ML techniques 212 may utilize unsupervised learning techniques such as clustering (e.g., K-means) to group customers with similar behavior and supervised learning techniques (e.g., decision trees, neural networks) to predict outcomes such as churn probability or future spending. ML techniques 212 may identify unusual behavior by detecting deviations in spending patterns or transaction volumes, flagging customers who deviate significantly from typical behaviors. ML models are typically trained on historical transaction data of similar business entities, including customer purchase patterns, transaction frequency, transaction amounts, and other relevant customer-specific financial records. This may assist businesses to intelligently take proactive measures, such as targeted marketing or retention efforts, based on insights derived from analysis of financial data 110.

In at least one example, intelligent data analytics 114, including predictions and classifications on financial data 110, may be displayed via user interface 700-A in form of various dynamic and interactive visual representations, including, but not limited to, pie charts, bar graphs, line graphs, heat maps, and scatter plots. These visualizations may serve to effectively communicate complex dimensional insights derived from financial data 110. For example, in UI 700-A, a pie chart 704 may visually represent a distribution of churn probability levels 706 for customer-related financial data. Pie chart 704 may include various churn probability categories such as very low, low, medium, high, and very high, offering a detailed spectrum of customer retention risk. A very high churn probability may refer to a group of customers who are highly likely to stop using a product or a service in a specified period of time in future. This visual representation (i.e., 704) may enable users to quickly understand a proportion of customers at different levels of risk for churn. Additionally, bar graphs and line graphs may be employed to show trends over time, such as changes in customer spending or engagement levels. Heat maps may be used to highlight geographical patterns, showing customer concentration and behavior across different regions. In UI 700-A, statistics, such as number of customers and their corresponding percentage for each churn probability level, may also be presented alongside visualizations. These visual elements provide users with actionable insights for decision-making, enabling businesses to identify at-risk customers and allocate resources efficiently for retention efforts.

In at least one example, visual representations offer interactive elements that enable users to explore financial data 110 in a more detailed and dynamic way. For instance, when user 102 clicks on any segment of pie chart 704, interface 700-A may provide further statistics or insights (e.g., 706) into specific churn probability level associated with that segment, as well as reveal additional intelligent classifications (e.g., groups 712) tied to level of churn, such as “Not Active,” “Anomalies,” “Frequent Buyers” and the like. This interactive functionality enables users 102 to dive deeper into customer data analytics, understanding not only overall churn distribution but also nuances of factors influencing customer retention. Additionally, RFI solution 108 may feature a bar graph 710 that visually illustrates relationship between sales and profits for different clients, customers, or other business entities with which any given business is conducting business. In this example, bar graph 710 may plot sales in millions on y-axis, with corresponding customers listed on x-axis, providing a clear dimensional analysis 214 of various business entities. By hovering on any bar within graph, user 102 may immediately view detailed financial information, such as specific sales figures and profit margins 714 associated with customer “Quali Global Supply.”

FIG. 7B is a screenshot 700-B of an extended user interface for intelligent data analytics 114 from UI 700-A, providing customer intelligence history 702 in accordance with at least one example. Customer intelligence history 702 may comprise of a detailed table 718 including ML-based categorized customer segments 712 alongside respective context descriptions in natural language format. Context description may be generated dynamically by analyzing semantic meaning and characteristics of customer segments, based on behaviors or attributes that categorize customer-related financial data into these segments. For example, a context description associated with a customer segment—“Clients with Unusual Behavior,” may comprise, “Newest customers, low profit rate group, their purchase rate is extremely rare.” Similarly, other customer segments in table 718 may be accompanied by relevant context description that helps in understanding characteristics of categorized segment 712.

Additionally, in at least one example, dimension-based intelligent data analytics includes statistics that quantitatively measure and analyze behaviors, financial activities, and interactions related to a specific dimension. For example, customer intelligent statistics 720 may encompass one or more financial metrics, including, but not limited to, total expenses, total purchases, expected purchases, frequency of customer, loyalty of customer, purchase interval, rating, expected CLV (customer lifetime value), and/or alive probability. These intelligent statistics 720 may be displayed, via UI 7-00-B, by selecting a specific customer segment. These financial metrics may provide a detailed understanding of each customer's financial and behavioral patterns, enabling business entities to assess customer value, predict future actions, and tailor strategies accordingly. RFI 108 tool leverages these statistics for segmentation, enabling businesses to categorize customers based on their purchasing behavior and lifecycle stage, thus enhancing customer retention efforts and driving more informed decision-making.

In at least one example, customer intelligence history table 718 and customer intelligence statistics 720 work together to provide holistic view of customer interactions and financial data 110 within RFI 108 tool. By analyzing financial data 110 presented in these tables, businesses may identify trends, detect anomalies, and predict future behaviors. For example, “Clients with Unusual Behavior” group may help businesses focus on new customers who may require additional attention to increase their engagement and profitability. Similarly, “Loyal Frequent Buyers” group may highlight customers who consistently contribute to revenue, enabling businesses to tailor loyalty programs and marketing strategies that may retain these valuable customers. Moreover, detailed statistics in table 720, such as total expenses and expected CLV, may provide insights into chart of accounts (COA) of every customer. ability of real-time financial intelligent (RFI) mechanisms to dynamically generate and update these tables may assist businesses to access most current and relevant financial data, supporting real-time decision-making and enhancing overall operational efficiency.

FIG. 7C is a screenshot displaying a user interface 700-C for interacting with Fine-Chat (financial intelligent chat) 116, in accordance with at least one example. In at least one example, real-time financial intelligence (RFI) 108 provides dimensional intelligence 112 and intelligent data analytics 114 by enabling users 102 to prompt Fine-Chat 116. Prompt may comprise a financial query 402 including one or more data elements (such as dimensions, financial metrics and one or more intents) in a natural language format. For example, a financial query 722 may comprise, sorting customer categories for 2022 based on number of orders. One or more dimensions in this financial query 722 may include a customer category, which specifies attribute being analyzed, and time for year 2022, which further narrows scope of query. Intent (or action) from financial query 722 is to sort out financial data based on a financial metric (e.g., value of orders) for a specified time. Processing of financial query 722 may involve query interpretation 404 and query analysis 406 that may result in dynamic generation one or more financial reports 122 (e.g., PNL reports). In at least one example, upon receiving query 722, Fine-Chat 116 may generate a response 724 by accessing aggregated data from financial report 614 and transforming it into human-readable interpretation. Response 724 may include one or more results based on one or more intents from financial query 722. Response 724 includes a result listing orders by customer category with set of dimensional values including, “Local Stores,” “Regional Stores,” and “Specialty Stores,” where number of orders for every customer category is also shown.

In at least one example, user interface 700-C includes additional controls at bottom of screen, such as “Send” 726, “Check Reports” 728, and “New Chat” 730. When user 102 selects “Check Reports” 728, RFI solution 108 may display a table 732 comprising one or more financial reports 734, dynamically generated in response to financial query 722. Table 732 may include details e.g., “Report Layout ID,” “Creation Date,” “Report Mapping Version,” “Report Date,” and “Column Layout.” In at least one example, financial report 734 may include various financial metrics or performance indicators, which can be further divided into categories and subcategories. For instance, performance indicator “Revenue” may be broken down into subcategories e.g., “Sales of Retail” (with regions such as North America, Europe, and Other) and “Sales Discounts” (also categorized by same regions). Generated financial report 734 may also include dimensional values for customer category, represented as columns in financial report 734. This would involve filtering and performing data analytics on financial data 110 based on relevant dimensions 206.

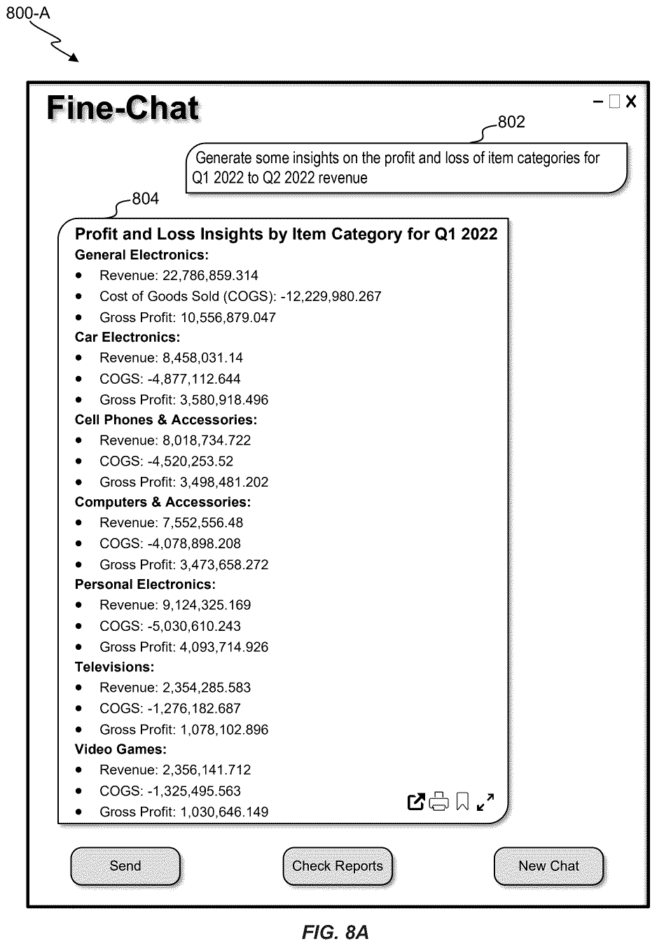

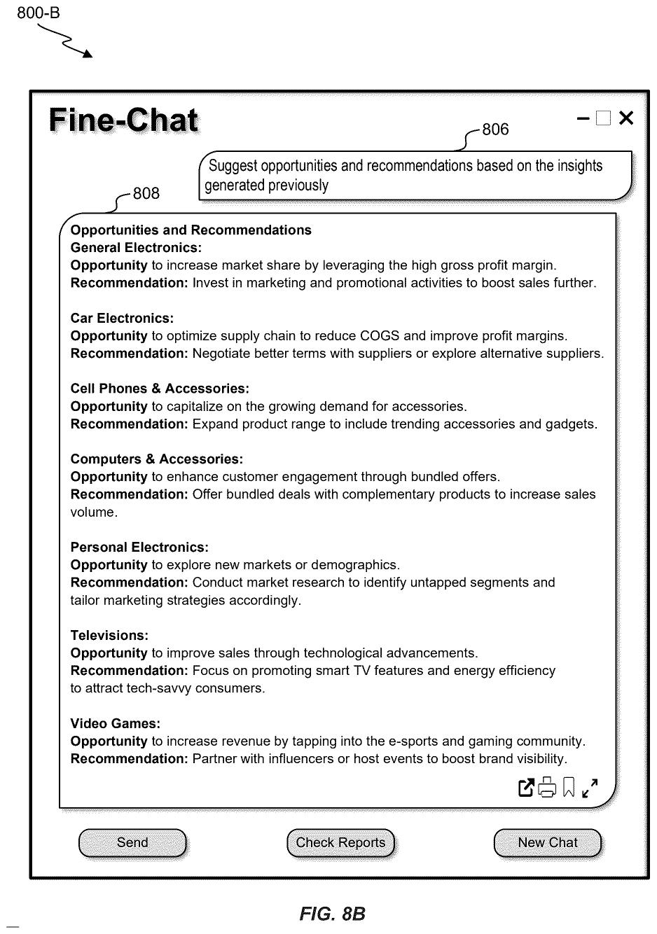

FIG. 8A is a screenshot of a user interface (UI) 800-A providing intelligent data analytics 114 for a second dimension via Fine-Chat 116, in accordance with at least one example. In at least one example, second dimension corresponds to items, services or products. Fine-Chat 116 leverages dimensional intelligence 112 and advanced data analytics 114, drawing from various dimensions such as customers, items, and countries, by utilizing one or more machine-learning techniques 212 such as a large language model (LLM). In at least one example, real-time financial intelligence (RFI) 108 enhances dimensional intelligence 112 by enabling users 102 to prompt Fine-Chat 116 and receive artificial intelligence (AI)-generated responses 412. These prompts may comprise financial queries 402, which may include multiple dimensions and intents expressed in a natural language format. For example, a financial query 802 may include, “Generate insights into profit and loss of item categories for Q 1 2022 and Q 2 2022.” Dimensions in this financial query 802 may include item category, specifying a dimension under analysis, and time period for year 2022, which further refines query's focus.

Financial query 802 may be processed, for example, including query interpretation 404 (tokenization 404a, intent recognition 404b, and entity recognition 404c). Intent of financial query 802 is to generate insights from financial data 110, specifically focusing on profit and loss of item categories for first two quarters of 2022. These processes may work together and may help to generate response 804 by accessing aggregated data from financial report 122 and transforming it into a human-readable interpretation. Response 804 may include one or more results based on intents from financial query 802. For example, response 804 may include a result listing profit and loss (PNL) indicators for various item categories such as “General Electronics,” “Car Electronics,” “Cell Phones & Accessories,” “Computers & Accessories,” “Personal Electronics,” “Televisions,” and “Video Games,” with financial metrics (PNL indicators) such as “Revenue,” “Cost of Goods Sold (COGS),” and “Gross Profit”. Further contextual queries or follow-up queries may be asked in as shown in screenshot 800-B.

FIG. 8B is a screenshot displaying a user interface 800-B of Fine-Chat 116 for contextual querying, in accordance with at least one example. In at least one example, financial query may comprise a contextual query (or a follow-up query) that builds upon or expands context of a previous financial query (e.g., 802), typically retrieving more specific details or performing additional analysis based on earlier results (e.g., 804). In at least one example, RFI tool 108 may serve as a financial advisor by enabling users to ask financial queries including a request for suggestions and recommendations related to a particular dimension or a generated result. For example, financial query 806 may include request as, “Suggest opportunities and recommendations based on insights generated previously,” resulting in generation of a response 808. Response 808 may help identify “opportunities” and generate “recommendations” across all dimensional values 208 of various item categories such as “General Electronics,” “Car Electronics,” “Cell Phones & Accessories,” “Computers & Accessories,” “Personal Electronics,” “Televisions,” and “Video Games,” with financial metrics such as “Revenue,” “Cost of Goods Sold (COGS),” and “Gross Profit”. Aiming to enhance profits and revenues, this generated analysis in natural language format may help in driving business expansion, improving revenue and profit growth, and subsequently contributing to overall success and long-term growth of business entity.

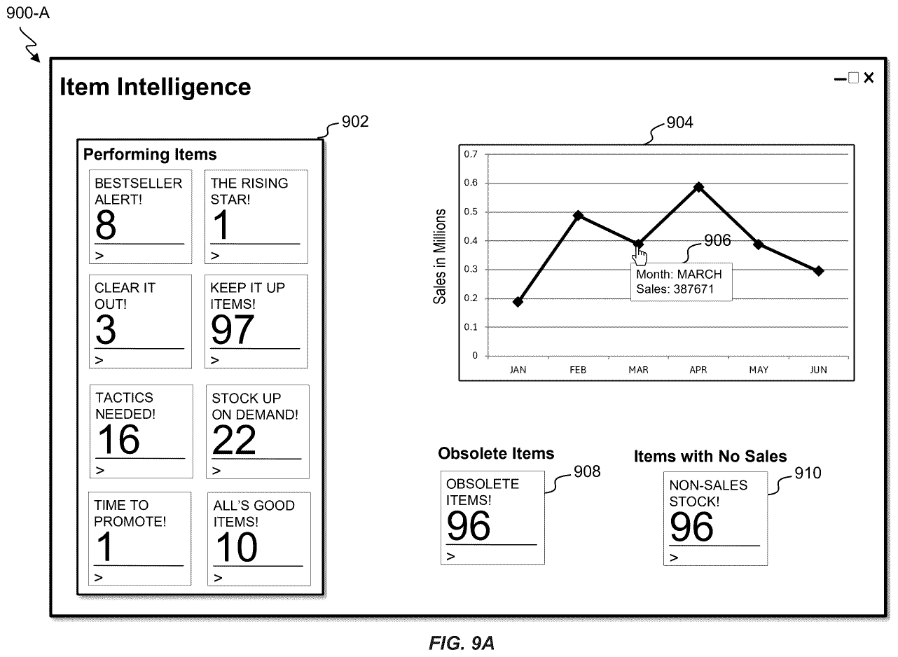

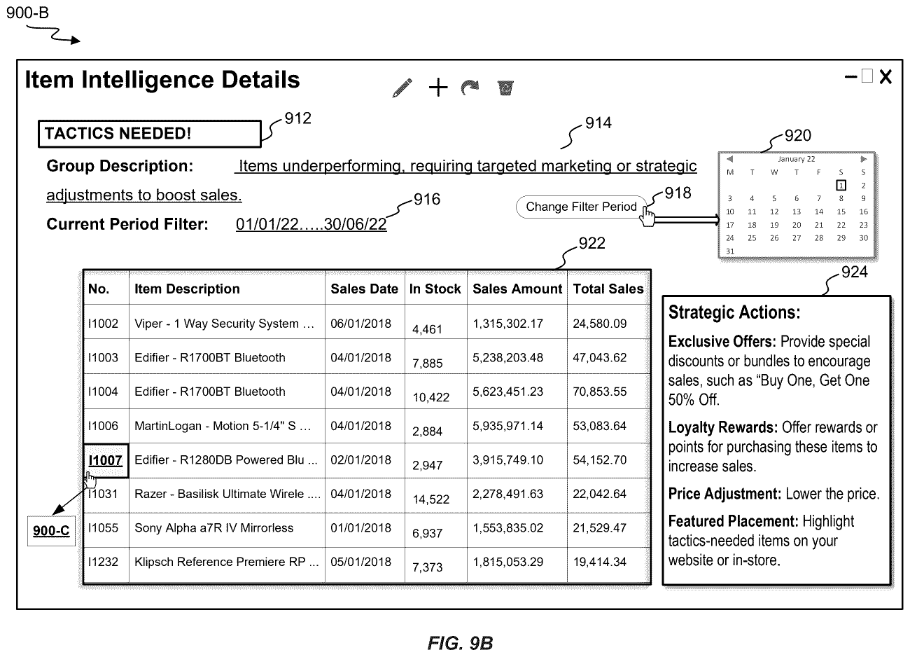

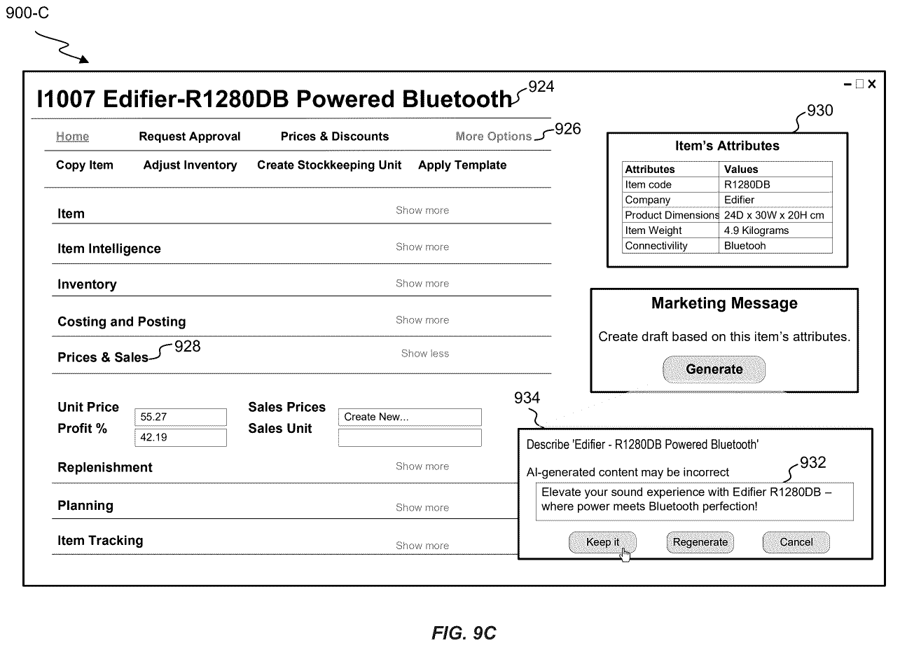

FIG. 9A is a screenshot displaying a user interface 900-A providing intelligent data analytics 114 for second dimension (i.e., item intelligence 120), in accordance with at least one example. Item intelligence 120 is configured to help businesses effectively manage their inventories by analyzing item-based financial data, such as sales revenue, profit margins, discounts and promotions, cost of goods sold, and inventory turnover rates for each item. In at least one example, item-related financial data may be extracted from relevant accounts in chart of accounts (COA), such as sales revenue accounts, inventory accounts, and cost of goods sold accounts, as well as transactional records that track item sales and stock movements. User interface 900-A may organize items into various performance groups (or segments) based on sales behavior by performing data analytics on item-based financial data to assist businesses in inventory management. These groups may include “Items with No Sales” 910, displaying count of unsold stock (e.g., 96), “Obsolete Items” 908, and “Performing Items” 902. “Performing Items” group 902 may be further divided into subgroups such as “Best Seller Alert,” “Rising Star,” “Clear It Out,” “Keep It Up,” “Tactics Needed,” “Stock Up on Demand,” “Time to Promote,” and “All's Good,” with item counts shown in individual boxes.

In at least one example, items-based financial data may be segmented into one or more groups using a combination of data analytics and predictive analytics. Data analytics help categorize items based on historical sales performance, identifying those with consistent sales, declining demand, or irregular patterns. For instance, items with strong past sales may be grouped into “Best Seller Alert” category, while items showing a sales decline may be classified as “Clear It Out.” Additionally, predictive analytics, leveraging historical sales data, may forecast future sales trends. This can lead to identification of potential “Rising Stars” items that have underperformed but show promise for future growth—or items that could benefit from targeted promotional efforts, categorized as “Time to Promote.” These predictive insights are derived by leveraging data analytics and serve to forecast potential actions for each group, helping businesses make data-driven decisions about inventory management, promotional campaigns, and sales strategies to optimize future performance.

In at least one example, one or more visualizations may be provided for displaying item intelligence 120. For example, sales for item category may be visualized over time such as shown by a line graph 904 that depicts monthly sales in millions for first two quarters of 2022. Data may be aggregated by day, month or year, providing a clear overview of trends and performance. In at least one example, various visualizations of dimensional intelligence 112 or data analytics 114 incorporate interactive GUI elements that further expand into an extended GUI or show a summary of data analytics. For example, for line graph 904, a user may view sales for a specific time point (e.g., specific month) by hovering over a point on graph e.g., 906 that also shows a count value of total sales at that specific time point, enabled through interactive user interactions. This may enable businesses to make data-driven decisions that streamline item management, reduce stockouts and overstock situations, and enhance pricing strategies. In addition to inventory management, item intelligence 120 may improve various aspects of business, such as product promotions, sales forecasting, and supplier management. By identifying high-performing items, predicting demand fluctuations, and providing recommendations for product replenishment, businesses may align their operations with market trends more effectively.

FIG. 9B is a screenshot displaying an extended user interface (UI) for a segment from FIG. 9A, in accordance with at least one example. In this example, extended UI 900-B includes “TACTICS NEEDED!” as indicated in screenshot. A dimensional context including a brief description of group may be found in a text field 914, generated dynamically by deploying one or more machine-learning techniques. Current period filter 916 is represented as a date field, enabling users to efficiently narrow down data displayed in table 922 by selecting a specific date. Users can change selected period by interacting with “Change Filter Period” 918, which opens a calendar interface 920. Interface 900-B may enable users to choose a specific date for filter, such as “01/01/2022.” Once date is selected, table 922 appears below calendar, presenting a list of items included in specific group. Table 922 includes relevant details such as item code, item description, sales date, total number of stocks currently available, and total sales amount, providing users with a detailed view of items within selected period. By selecting an individual item code corresponding to a particular item e.g., 924, user may navigate to a more detailed view of that item in a separate graphical user interface, 900-C.

In at least one example, predictive analytics may further include tailored marketing suggestions (or strategic actions) for each segment associated with a dimension, configured to improve performance based on characteristics of segment. For instance, for a “TACTICS NEEDED!” segment, UI 900-B includes strategic actions 924 to take, such as targeted promotions, adjusting pricing strategies, or increasing visibility through advertising campaigns. These actions are designed to address underperformance of items and help drive sales growth. Conversely, for a “Best Seller Alert!” segment, suggestions may include targeted advertising campaigns or spotlight in trending section. Each segment receives a customized set of marketing strategies or recommendations based on its unique performance patterns, enabling businesses to deploy more effective, data-driven strategies to enhance sales and customer engagement.

FIG. 9C is a screenshot displaying a user interface (UI) 900-C that provides details for a specific entity selected from user interface 900-B, in accordance with at least one example. In at least one example, graphical user interface 900-C may include various options, such as “Home,” “Request Approval,” “Prices & Discounts,” “Copy Item,” “Adjust Inventory,” “Create Stockkeeping Unit,” “Apply Template,” and “More Options.” These options may provide users with easy access to information and additional actions related to selected entity, which is displayed in top section 926 of user interface 900-C. Details for selected entity, such as “I1007 Edifier-R1280DB Powered Bluetooth” include various parameters that can be configured within “Item” section, such as item code, measurement unit, and item type. Similarly, users can choose to include or exclude entity from item intelligence processing in “Item Intelligence” section. Each section may be further explored by selecting “Show More” option next to each section. For example, “Prices & Sales” section can be expanded to display detailed information such as unit price, sales price, profit %, and sales units.

On right side of UI 900-C, users may create an AI-generated marketing message based on item's attributes 930. This “Marketing Message” 932 may be generated by machine-learning techniques 212, such as a large language model (LLM), which analyzes item's attributes 930 and generates a contextually relevant message in natural language. Message reflects item's associated category (e.g., “Electronic Accessories”) and can assist users in content creation or decision-making by providing a tailored, marketing-ready draft.

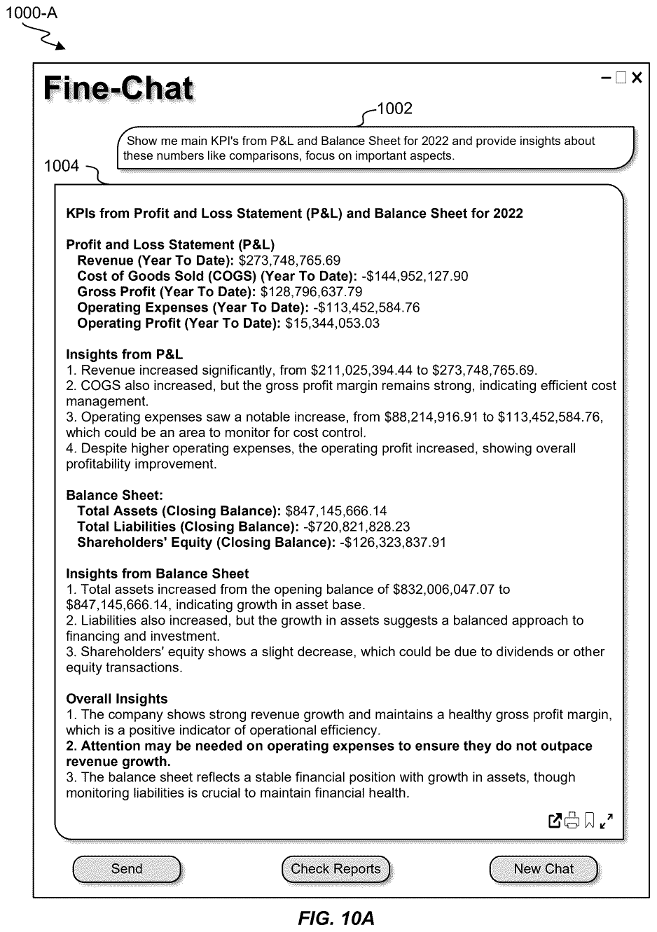

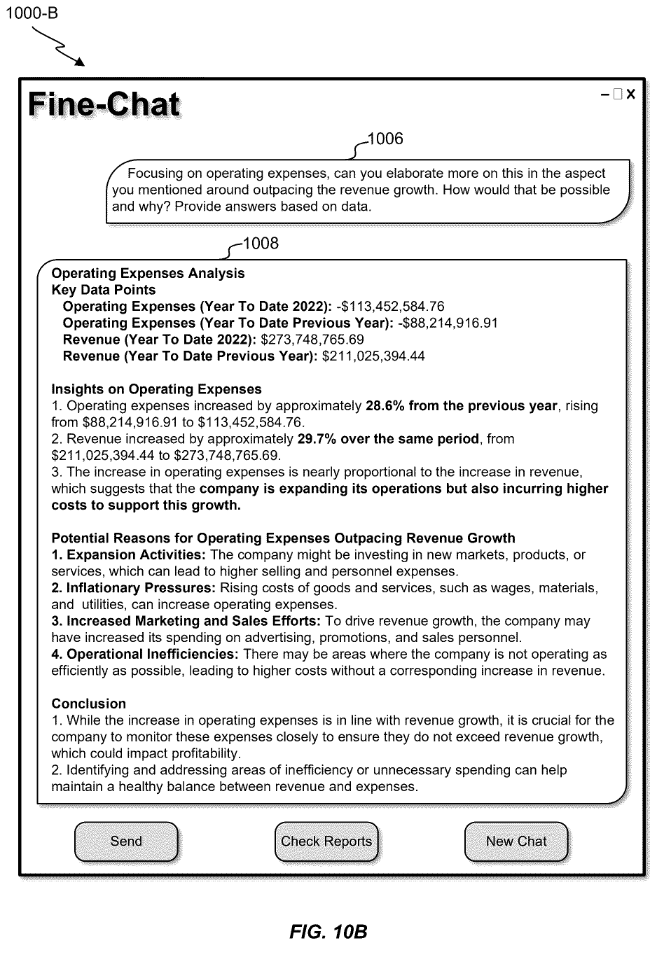

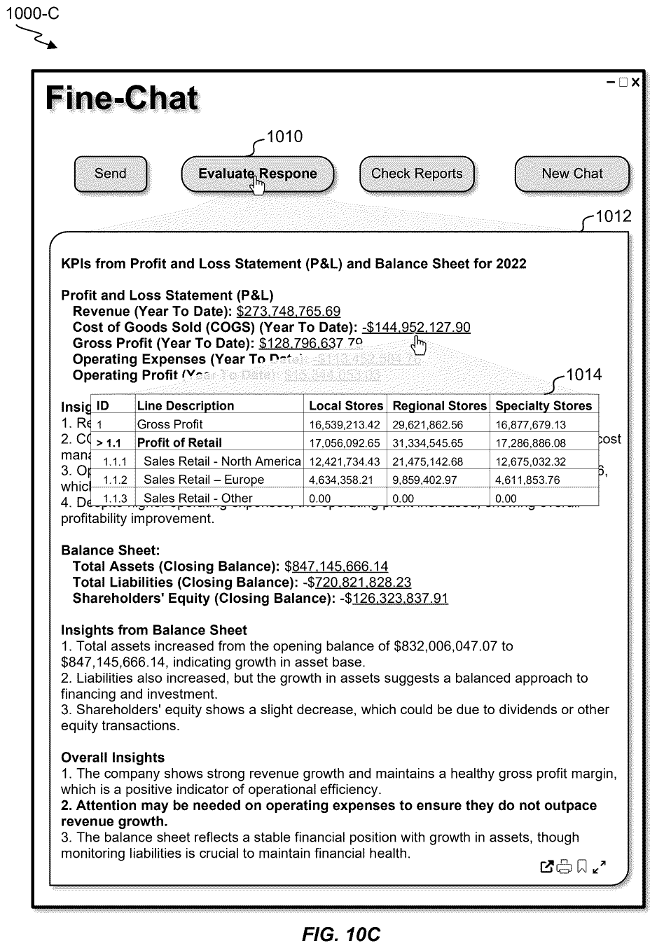

FIG. 10A is a screenshot displaying a user interface 1000-A of financial intelligent chat (Fine-Chat) 116 for providing financial advice or recommendations 124, in accordance with at least one example. In at least one example, a financial query may comprise a plurality of intents and/or a request for creation of financial reports (or financial statements) based on dimensions, where intents may be dependent or independent of each other. Query may involve request for financial reports (e.g., profit and loss statement (PNL) and balance sheet), dimensions such as time period (e.g., a specific year e.g., 2021 or 2022), and key performance indicators (KPIs) (or financial metrics) that are integral to understanding financial health of a business entity. A balance sheet may refer to a financial statement used by a business entity to provide a snapshot of a financial position of business entity at a specific point in time. It may summarize performance indicators such as assets, liabilities and equity of business entity. Therefore, a financial query 1002 may include a request to extract key performance indicators (KPIs) from financial statements such as profit and loss (PNL) statement and balance sheet for a specified period. Plurality of intents from financial query 1002 may include data extraction, comparative analysis, and insight generation, where user aims to retrieve specific financial metrics (or KPIs), compare these metrics across periods or accounts, and derive insights that inform decision-making.

In at least one example, PNL and balance sheets may be generated by aggregating transactional data from (structured) financial data 110 e.g., chart of accounts, where each account reflects specific financial categories such as revenues, expenses, assets, and liabilities. These reports may be created by applying data analytics involving business logic and calculations, retrieving information directly from chart of accounts to display financial health through financial metrics. RFI 108 may employ machine-learning and AI-driven techniques to dynamically generate these reports in real-time based on financial query 402, providing real-time and accurate financial insights tailored to user's query.

In response to financial query 1002, Fine-Chat 116 may generate a (formatted) response 1004 that includes a first result corresponding to first intent from plurality of intents. For example, first intent involves showing key performance indicators (KPIs) from profit and loss (PNL) statement and balance sheet for 2022. Corresponding first result generated in response 1004 may include calculated values for KPIs from PNL statement, such as “Revenue,” “Cost of Goods Sold (COGS),” “Gross Profit,” “Operating Expenses,” and “Operating Profit” for year 2022, as requested in query. Additionally, KPIs from balance sheet may include “Total Assets,” “Liabilities,” and “Shareholders'Equity.” It should be noted that in first result, costs and expenses are presented with a negative sign (“−”) while profits and revenues are displayed with a positive sign (“+”), ensuring clarity in financial data representation.

Similarly, generated response 1004 may include a second result that corresponds to second intent of plurality of intents, which is based at least in part on first intent. For example, second intent corresponds to providing comparative insights about these numbers found in first result. Generated response 1004 may include corresponding second result including insights from each of reports (e.g., PNL statement and balance sheet). Insights from PNL may provide an interpretation of a net change (e.g., from 2021 to 2022) in revenue, COGS, operating expenses and profits in a natural language format. Similarly, insights from balance sheet may display a net change in total assets, liabilities and shareholder's equity. Third intent of plurality of intents may include focusing on important aspects and corresponding third result may comprise overall insights. These insights may highlight company's overall growth here showcasing a strong revenue expansion and a healthy gross profit margin as key performance indicators of operational efficiency.

Additionally, in at least one example, generated response 1004 may include specific formatting based on various parameters e.g., structure of financial data and its intended presentation, context of query. For instance, key points such as KPIs from PNL statement and balance sheet may be emphasized using formatting techniques such as bold text for important values or headings. Response may be structured in different sections e.g., presenting a new paragraph for each result (e.g., PNL and balance sheet), making it visually distinct and easy to follow. Additionally, sub-headings may be used to categorize KPIs, such as “Revenue” or “Operating Profit,” with further emphasis on critical figures through underlining or bolding. For example, generated response 1004 may emphasize importance of monitoring KPIs by highlighting key figures, such as operating expenses, in bold text to draw attention to potential concerns, such as operating expenses should not grow faster than revenue. Balance sheet may also reflect status of financial position here mentioned as stable, with growth in assets, though ongoing attention to liabilities may be essential for maintaining financial health.

FIG. 10B is a screenshot displaying a user interface 1000-B of Fine-Chat 116 for contextual querying of financial advice or recommendations, in accordance with at least one example. In at least one example, financial query may comprise a contextual query (or a follow-up query) that builds upon or expands context of a previous financial query, typically retrieving more specific details or performing additional analysis based on earlier results. In at least one example, RFI 108 tool may offer services as a financial advisor by enabling users, via an interface of Fine-Chat 116, to ask queries. In at least one example, financial query 1006 may include a request for financial advice or recommendations 124. Response 1004, generated by financial query 1002 from interface 1000-A, includes valuable insights, drawing attention to operating expenses. Therefore, user may input a contextual or a follow-up query 1006 to further drill down into previous response 1004 and investigate key performance indicator (KPI) focusing on operating expenses. For example, user may ask, “Can you elaborate more on aspect you mentioned regarding operating expenses outpacing revenue growth? How could this happen, and why? Please provide data-driven insights.” This follow-up query may enable a deeper analysis, leveraging data that may explain dynamics and potential risks associated with operating expenses exceeding revenue growth.

In response to financial query 1006, LLM may first interpret query by identifying data entities (such as “operating expenses” and “revenue growth”) and intents (elaborating on relationship between operating expenses and revenue growth). It may then perform query analysis 406 by retrieving relevant financial data, such as operating expenses and revenue growth metrics, and contextualizing these metrics within query's dimensions or other parameters (e.g., time period, industry benchmarks). To generate recommendation, model may apply predictive modeling techniques such as regression analysis or trend forecasting, utilizing historical data patterns and financial performance trends to provide insights on how and why operating expenses might outpace revenue growth. Based on analysis, it may recommend strategies such as cost-cutting measures or efficiency improvements to mitigate risk of unsustainable expense growth relative to revenue.

Query response 1008 may provide a comparison between operating expenses and revenue for current year and previous year. It further highlights growth rates for both operating expenses and revenue, presenting differences in a clear and easily understandable natural language format. These insights may enable users to identify trends and discrepancies between two indicators, such as how company is expanding its operations while simultaneously incurring higher costs to support this growth. In at least one example, financial query 1006 may further comprise another intent to ask potential reasons for a specific financial event. In response, Fine-Chat may generate several potential reasons for financial event e.g., operating expenses outpacing revenue growth. These potential reasons may include expansion activities, where investments in new markets, products, or services can lead to higher sales and personnel costs or inflationary pressures, such as rising costs of goods, wages, and utilities, can also increase operating expenses.

FIG. 10C is a screenshot of a user interface 1000-C for a response evaluation, in accordance with at least one example. In at least one example, disclosed RFI mechanisms provide an evaluation of a generated response 1012 or a generated financial report. “Evaluate Report” 1010, highlighted in FIG. 10C, provides an interactive and intuitive interface for analyzing generated response 1012. This functionality enables users to drill down into specific financial metrics (underlined numbers), such as revenue, cost of goods sold (COGS), and operating expenses, tracing these aggregated numbers back to underlying transaction records or detailed PNL report 1014 that contribute to these numbers. By offering a clear pathway from high-level summaries to granular data, support precise financial analysis and decision-making is supported, ensuring transparency and accuracy in evaluating business performance.

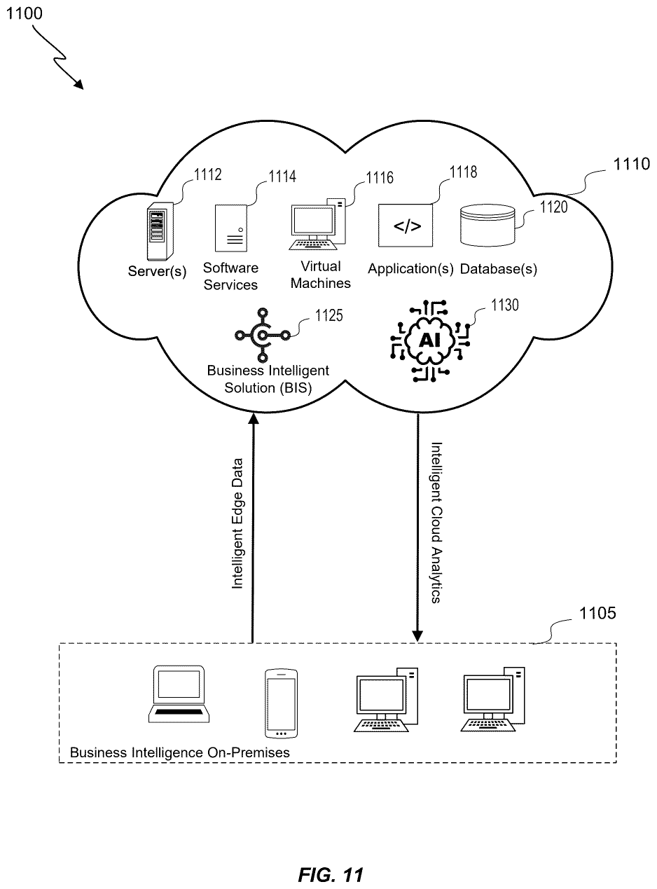

FIG. 11 is a schematic of an environment for integration of real-time financial intelligent (RFI) 108 mechanisms with a cloud 1110, in accordance with at least one example. In at least one example, real-time financial intelligent (RFI) 108 may run as software as a service (SaaS). In at least one example, real-time financial intelligence 108 tool that provides dimensional intelligence 112, intelligent data analytics 114 and financial intelligent chat (Fine-Chat) 116 is integrated with a business intelligent solution (BIS) 1105. Here, “business intelligent solution” (BIS) or “enterprise intelligent solution” may generally refer to use of AI-based business analytics at organizational or enterprise level. It may involve collecting, analyzing, and interpreting data from one or more sources within a business entity to make informed decisions. A business intelligent solution (BIS) is a unified business management solution and/or enterprise resource planning (ERP) system that may or may not integrate a cloud computing environment. Such a system may encompass a set of tools, technologies, and processes configured to facilitate financial data analysis, reporting, making informed decisions, and improving overall efficiency of a business entity.

In at least one example, environment 1100 includes an integration of cloud 1110 with an on-premises BIS 1105 with multiple clients. This integration may involve connecting and leveraging cloud-based services to enhance capabilities of existing on-premises BI solution 1105. Here, on-premises BIS 1105 may refer to a BI solution that is installed, operated, and maintained within physical premises or infrastructure of an organization in contrast to a cloud-based BI solution. For integration of data on cloud 1110, secure connections and protocols may be established for present tool, for example, setting up application programming interface (APIs) and connectors or data transfer mechanisms. In at least one example, on-premises BIS 1105 can access cloud 1110 through a communication network for sending intelligent edge data and receiving intelligent cloud analytics. In at least one example, on-premises BI solution 1105 solution can utilize cloud-based AI enabling cloud-based analytics and ML services for enhanced analytical capabilities of BI system. This may involve running advanced analytics, predictive modeling or generating insights using cloud-based tools.

In at least one example, one or more clients or users log in using a web browser, computing device 104 (e.g., phone or tablet), or through API to access an application software for RFI solutions. Cloud 1110 may be termed as an intelligent cloud providing AI-based cloud application(s) 1118 or software services 1114. Within cloud 1110, software services 1114 may encompass a range of functionalities that may include middleware, data processing, and application services. These services 1114 may facilitate seamless communication and collaboration among various components of cloud 1110. In at least one example, cloud 1110 may host financial database 106 that stores and manages data efficiently. One or more servers 1112 in cloud 1110 may provide computing power to run application(s) 1118, services 1114, and processes. In at least one example, server(s) 1112 may also contribute to scalability and responsiveness of cloud environment.

Virtual machines 1116 in cloud 1110 may offer scalable and flexible computing resources that can be used for multiple clients or customers. Deployment of virtual machines 1116 may enable optimization in resources utilization. Cloud applications or web applications 1118 may provide a user-friendly interface to access and interact with various services within cloud environment. An AI module 1130 within cloud 1110 may offer enhanced capabilities. In at least one example, cloud 1110 may offer intelligent cloud analytics, insights generation and decision-making processes using trained models. In at least one example, BI solution 1105 (e.g., a central solution) can take advantage of cloud-based applications through intelligent cloud 1110. In at least one example, each BI solution 1105 that connects to cloud 1110 may be able to replicate data from on-premises to cloud tenant. In at least one example, one or more clients or users 102 can leverage cloud 1110 for storage of financial data (structured) 110, performing intelligent data analytics, and/or using ML techniques.

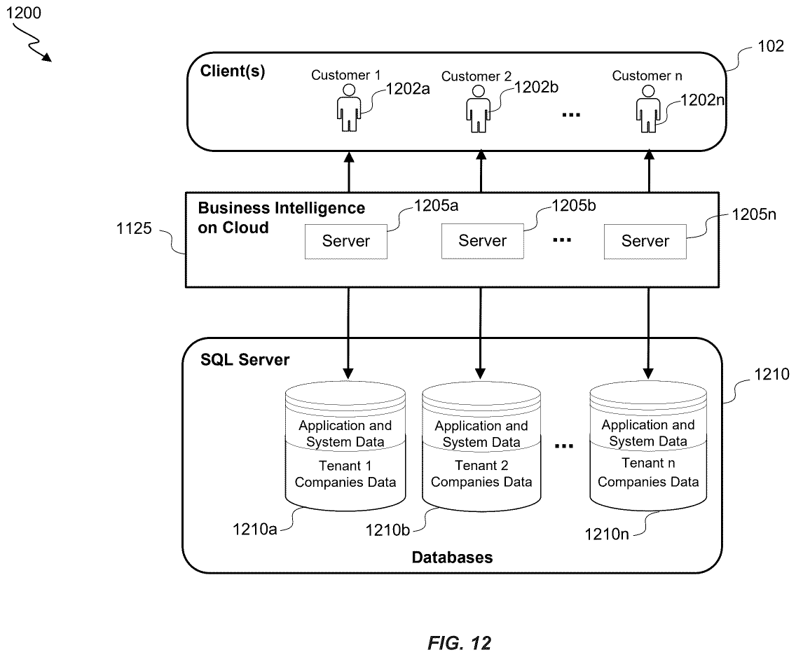

FIG. 12 is a schematic of a cloud deployment model, in accordance with at least one example. Here, one or more clients or users 102 refer to a business entity or a group of legal entities. In at least one example, system 1200 includes one or more clients (e.g., 1202a, . . . , 1202n) or users 102 to interact with cloud-based business intelligence solution (BIS) 1125. It should be appreciated that system 1200 depicted in FIG. 12 may have other components than those depicted. FIG. 12 illustrates one example of system. In at least one example, system 1200 may have more or fewer components than shown in FIG. 12, may combine two or more components, or may have a different configuration or arrangement of components.

One or more clients or users 102 may interact with a cloud-based BIS 1125 by configuring a client application e.g., a web browser, a desktop, or a mobile application. One or more clients or users 102 may communicate with BI servers e.g., 1205a, 1205b . . . 1205n which are hosted in cloud 1110. In response, BI server(s) 1205a may manage business logic, process requests, and interact with database. In at least one example, cloud-based BIS 1125 may utilize a database management system (DBMS) such as database 1210 (e.g., SQL server database) that is responsible for storing and managing underlying data of one or more clients or users 102, including financial data 110. When one or more clients or users 102 perform actions via BI server(s) 1205 client application (e.g., creating a sales order, updating inventory, or saving a financial report), BI server 1205 may process these actions. Business logic may be applied to enable data consistency and to perform necessary calculations. Processed data may be stored in database 1210 (e.g., SQL server database) and accessed through an instance of server 1205. Each module in BIS 1125 (e.g., finance, sales, reporting) may have a corresponding table in SQL database to organize and store data.

An external solution, such as described in at least one example, can be integrated with BIS 1125 using application program interfaces (APIs). These integration points may enable reporting tool to request specific data or perform actions within BIS, in accordance with at least one example. In at least one example, if a BIS is deployed in a cloud, SQL server database 1210 may also be hosted in cloud 1110. This deployment may enhance scalability, accessibility, and benefits of cloud computing. A BIS may include an application (e.g., code) and business data (e.g., client data). In at least one example, there can be two ways to deploy a BIS on cloud 1110. In at least one example, BIS can be installed as a single-tenant deployment by default. In a single-tenant deployment, application and business data are stored in same database. Each customer solution has its own business central server and database, as illustrated in FIG. 12. For example, a client 1202a has a dedicated BI server 1205a on cloud, and one SQL database 1210a, where application and business data of a tenant company are stored together. In a multitenant deployment, application and business data are stored in separate databases, in accordance with at least one example. In at least one example, there is a single BI server 1205 and a single application database for multiple customers. In at least one example, each individual customer has an individual proprietary database for storing business data.

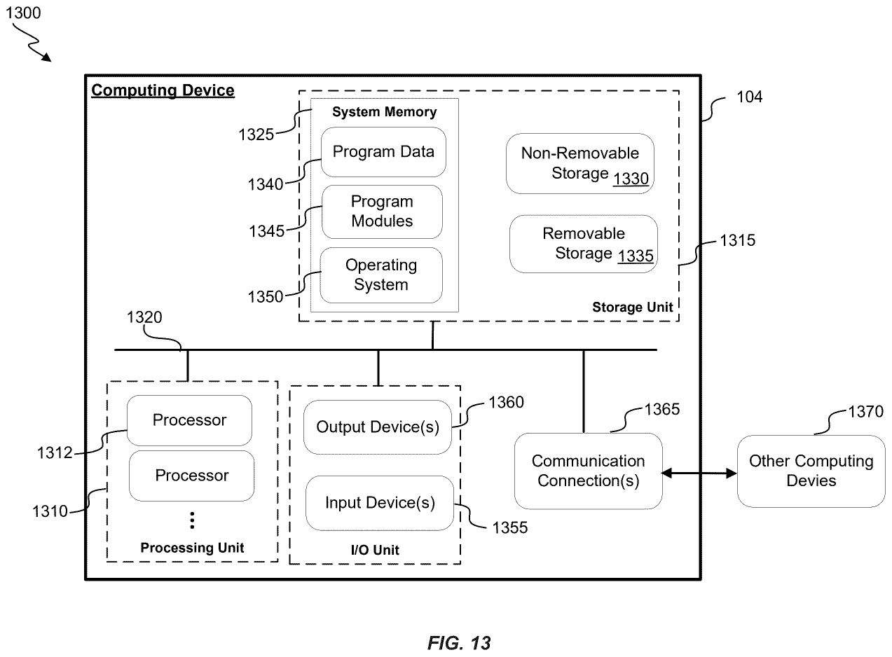

FIG. 13 is a schematic of computing device 1300 that performs real-time financial intelligence 108, in accordance with at least one example. In at least one example, functionality described herein can be performed, at least in part, by one or more hardware logic components. For example, and without limitation, illustrative types of hardware logic components that can be used include field-programmable gate arrays (FPGAs), application-specific integrated circuits (ASICs), application specific standard products (ASSPs), system-on-a-chip systems (SOCs), complex programmable logic devices (CPLDs), etc., where analog, digital, and/or mixed signal and other functionality can be implemented in a substrate.

FIG. 13 and following description are intended to provide a brief, general description of suitable computer system 1300 in which various aspects can be implemented. While description above is in general context of computer-executable instructions that can run on one or more computers, those skilled in art will recognize that a novel implementation also can be realized in combination with other program modules and/or as a combination of hardware and software. Computer system 1300 for implementing various aspects includes computing device 104 that further comprises a processing unit 1310 having processor(s) 1312 (also referred to as microprocessors), a computer-readable storage medium (where medium is any physical device or material on which data can be electronically and/or optically stored and retrieved) such as a storage unit 1315 (computer readable storage medium/media also include magnetic disks, optical disks, solid state drives, external memory systems, and flash memory drives), and a system bus 1320. In at least one example, processing unit 1310 can be any of various commercially available microprocessors such as single-processor, multi-processor, single-core units, and multi-core units of processing and/or storage circuits. Moreover, those skilled in art will appreciate that novel system and methods can be practiced with other computer system configurations, including minicomputers, mainframe computers, as well as personal computers (e.g., desktop, laptop, tablet PC, etc.), hand-held computing devices, microprocessor-based or programmable consumer electronics, and the like, each of which can be cooperatively coupled to one or more associated devices.

In at least one example, computing device 104 can be one of several computers employed in a datacenter and/or computing resources (hard-ware and/or software) in support of cloud computing services for portable and/or mobile computing systems such as wireless communications devices, cellular telephones, and other mobile-capable devices. Cloud computing services include, but are not limited to, infrastructure as a service, platform as a service, software as a service, storage as a service, desktop as a service, data as a service, security as a service and APIs (application program interlaces) as a service, for example. In at least one example, system memory 1325 can include computer-readable storage (physical storage) medium such as a volatile memory (e.g. random-access memory (RAM)) and a non-volatile memory (e.g., (ROM). A basic Input/output system (BIOS) can be stored in non-volatile memory and includes basic routines that facilitate communication of data and signals between components within computing device 104, such as during startup. Volatile memory also includes high-speed RAM such as static RAM for caching data.

In at least one example, computing device 104 may have additional features or functionality. For example, computing device 104 may also include additional data storage devices (removable and/or non-removable) such as, for example, magnetic disks, optical disks, or tape. Such additional storage is illustrated in FIG. 13 by removable storage 1335 and non-removable storage 1330. Computer-readable media may include at least two types of computer-readable media, namely computer storage media and communication media. Computer storage media may include volatile and non-volatile, removable, and non-removable media implemented in any method or technology for storage of information, such as computer readable instructions, data structures, program modules, or other data.

In at least one example, system memory 1325, removable storage 1335, and non-removable storage 1330 are all examples of computer storage media, comprising storage unit 1315. Computer storage media includes, but is not limited to, RAM, ROM, EEPROM, flash memory or other memory technology, CD-ROM, digital versatile disks (DVD), or other optical storage, magnetic cassettes, magnetic tape, magnetic disk storage or other magnetic storage devices, or any other non-transmission medium that can be used to store desired information and which can be accessed by computing device 104. Any such computer storage media may be part of computing device 104. Moreover, computer readable media may include computer-executable instructions that, when executed by processor(s) 1312, perform various functions and/or operations described herein. In contrast, communication media may embody computer readable instructions, data structures, programming modules, or other data in a modulated data signal, such as a carrier wave, or other transmission mechanism. As defined herein, computer storage media does not include communication media.

In at least one example, computing device 104 may also have input device(s) 1355 such as keyboard, mouse, pen, voice input device, touch input device, etc. Output device(s) 1360 such as a display, speakers, printer, etc. may also be included. These devices are well known in art and are not discussed at length here. In at least one example, computing device 1305 may also contain communication connection(s) 1365 that allows device to communicate with other computing devices 1370, such as over a network. These networks may include wired networks as well as wireless networks. In at least one example, communication connections 1365 is one example of communication media. Here, computing device 104 is one example of a suitable device and is not intended to suggest any limitation as to scope of use or functionality of various embodiments described.

Other well-known computing devices 1370, systems, environments and/or configurations that may be suitable for use with embodiments include, but are not limited to personal computers, server computers, hand-held or laptop devices, multiprocessor systems, microprocessor-based systems, set top boxes, game con soles, programmable consumer electronics, network PCs, minicomputers, mainframe computers, distributed computing environments that include any of above systems or devices, and/or the like. For example, some or all components of computing device 104 may be implemented in a cloud computing environment, such that resources and/or services are made available via a computer network for selective use by user devices.

By way of example, and not limitation, system memory 1325 also illustrates program modules 1345, which may include client applications, Web browsers, mid-tier applications, relational database management systems (RDBMS), etc., program data 1340, and an operating system 1350. By way of example, operating system 1350 may include various versions of Microsoft Windows®, Apple Macintosh®, and/or Linux operating systems, a variety of commercially-available UNIX® or UNIX-like operating systems (including without limitation variety of GNU/Linux operating systems, Google Chrome OS, and the like) and/or mobile operating systems such as iOS, Windows® Phone, Android OS, BlackBerry® OS, and Palm® OS operating systems. Generally, programs include routines, methods, data structures, other software components, etc., that perform tasks, functions, or implement particular abstract data types. All or some of operating system 1350, program modules 1345, and/or program data 1340 can also be cached in memory such as volatile memory and/or non-volatile memory, for example. It is appreciated that disclosed architecture can be implemented with various commercially available operating systems or combinations of operating systems (e.g., virtual machines).

In at least one example, system bus 1320 provides an interface for system components including, but not limited to, system memory 1325, to processing unit 1310. In at least one example, system bus 1320 can be of any of several types of bus structure that can further interconnect to memory bus (with or without controller), and a peripheral bus (e.g., PCI, PCIe, AGP, LPC, etc.), using any of a variety of commercially available bus architectures.

In at least one example, one or more machine-readable storage media (e.g., memory) are provided which stores one or more machine-executable instructions. In at least one example, when one or more machine-executable instructions are executed by a machine (e.g., one or more processors), one or more methods described herein are performed. In at least one example, machine-readable storage media is a tangible non-transitory machine-readable media. In at least one example, machine-readable storage media comprises one of volatile or non-volatile memory, or a combination of them.

Following are additional examples provided in view of above-described implementations. Here, one or more features of example, in isolation or in combination, can be combined with one or more features of one or more other examples to form further examples also falling within scope of disclosure. As such, one implementation can be combined with one or more other implementation without changing scope of disclosure.

Example 1 is a computer-implemented method comprising accessing financial data of a business entity from a financial database, wherein the financial data comprises a plurality of structured financial records, wherein a structured financial record of the plurality of structured financial records comprises account information associated with a transaction; generating, based at least in part on the financial data, a set of dimensions by applying one or more machine-learning techniques that are configured to identify associations between a dimension of the set of dimensions and a set of relevant structured financial records, wherein the dimension of the set of dimensions corresponds to a distinct attribute of the financial data linked to the account information; mapping automatically a set of dimensional values by accessing the set of relevant structured financial records to the dimension of the set of dimensions; dynamically generating a dimensional context associated with the dimension of the set of dimensions by applying a first large language model of the one or more machine-learning techniques, the dimensional context corresponds to an interpretation of the dimension in a natural language format; receiving, via an interactive user interface, a financial query in the natural language format comprising at least one intent to be performed on the financial data based on one or more dimensions of the set of dimensions, wherein the at least one intent corresponds to an action; dynamically generating, based on the financial query, a financial report that corresponds to a dimension of the one or more dimensions by performing data analytics, the financial report includes one or more financial metrics for the financial data that is filtered and categorized based on the dimension of the one or more dimensions and the associated set of dimensional values; and generating, based at least in part on the financial report, the dimensional context, and the financial query, a formatted response including at least one result that corresponds to the at least one intent from the financial query in the natural language format by deploying a second large language model of the one or more machine-learning techniques, wherein the at least one result includes the data analytics involving the one or more financial metrics and the one or more dimensions.

Example 2 is a computer-implemented method according to any example herein, particularly example 1, further including performing a query interpretation to identify the at least one intent and one or more data entities from the financial query, wherein the one or more data entities include the one or more dimensions and the one or more financial metrics; performing a contextual analysis configured to analyze a context of the financial query and one or more dimensional contexts associated with the identified one or more dimensions; and performing, based on the contextual analysis, data aggregation that includes: performing the data analytics in accordance with the identified at least one intent, and mapping the identified one or more dimensions to relevant financial data by retrieving the financial database.

Example 3 is a computer-implemented method according to any example herein, particularly example 1, further including receiving a contextual query that is based at least in part on the financial query, including one or more parameters and an intent, wherein a parameter of the one or more parameters is based at least in part on the one or more dimensions or the at least one result; and generating, via the second large language model of the one or more machine-learning techniques, a response based on the contextual query.

Example 4 is a computer-implemented method according to any example herein, particularly example 3, wherein the intent corresponds to a request for a financial recommendation, and wherein the response includes a result comprising the financial recommendation in the natural language format.

Example 5 is a computer-implemented method according to any example herein, particularly example 1, further including extracting a first subset of financial data from the financial data based on a first dimension of the set of dimensions, wherein the first dimension corresponds to a customer attribute of the financial data; applying the one or more machine-learning techniques that are configured to identify behavior patterns, including regular and anomalous behaviors, from the first subset of financial data, wherein the one or more machine-learning techniques are trained on historical behavior patterns associated with the first dimension; predicting a churn probability of a structured financial record of the first subset of financial data based on the identified behavior patterns; categorizing the first subset of financial data into one or more segments based on the predicted churn probability and the identified behavior patterns; and providing an interactive graphical user interface including one or more visual representations associated with the one or more segments, wherein the interactive graphical user interface displays a segment context, and the data analytics associated with a segment of the one or more segments.

Example 6 is a computer-implemented method according to any example herein, particularly example 1, further including extracting a second subset of financial data from the financial data based on a second dimension of the set of dimensions, wherein the second dimension corresponds to an item, product or service attribute of the financial data; analyzing the second subset of financial data by applying the one or more machine-learning techniques that are configured to perform the data analytics and predictive analytics; segmenting the second subset of financial data into one or more segments based on the data analytics including sales patterns and based on the predictive analytics that leverages data analytics to forecast potential actions for a group of the one or more groups; and providing an interactive graphical user interface including one or more visual representations associated with the one or more segments, wherein the interactive graphical user interface displays a segment context, and the data analytics associated with a segment of the one or more segments.

Example 7 is a computer-implemented method according to any example herein, particularly example 6, further including accessing a specific entity from a set of entities that is associated with a dimensional value of the set of dimensional values; and generating, via a third large language model of the one or more machine-learning techniques, a marketing message in the natural language format based on entity attributes.

Example 8 is a system one or more data processors; and a non-transitory computer readable storage medium containing instructions which, when executed on the one or more data processors, cause the one or more data processors to perform actions including: access financial data of a business entity from a financial database, wherein the financial data comprises a plurality of structured financial records, wherein a structured financial record of the plurality of structured financial records comprises account information associated with a transaction; generate, based at least in part on the financial data, a set of dimensions by applying one or more machine-learning techniques that are configured to identify associations between a dimension of the set of dimensions and a set of relevant structured financial records, wherein the dimension of the set of dimensions corresponds to a distinct attribute of the financial data linked to the account information; map automatically a set of dimensional values by accessing the set of relevant structured financial records to the dimension of the set of dimensions; dynamically generate a dimensional context associated with the dimension of the set of dimensions by applying a first large language model of the one or more machine-learning techniques, wherein the dimensional context corresponds to an interpretation of the dimension in a natural language format; receive, via an interactive user interface, a financial query in the natural language format comprising at least one intent to be performed on the financial data based on one or more dimensions of the set of dimensions, wherein the at least one intent corresponds to an action; dynamically generate, based on the financial query, a financial report that corresponds to a dimension of the one or more dimensions by performing data analytics, wherein the financial report includes one or more financial metrics for the financial data that is filtered and categorized based on the dimension of the one or more dimensions; and generate, based at least in part on the financial report, the dimensional context, and the financial query, a formatted response including at least one result that corresponds to the at least one intent from the financial query in the natural language format by deploying a second large language model of the one or more machine-learning techniques, wherein the at least one result includes the data analytics involving the one or more financial metrics and the one or more dimensions.

Example 9 is a system of any example herein, particularly example 8, further including performing a query interpretation to identify the at least one intent and one or more data entities from the financial query, wherein the one or more data entities include the one or more dimensions and the one or more financial metrics; performing a contextual analysis configured to analyze a context of the financial query and one or more dimensional contexts associated with the identified one or more dimensions; and performing, based on the contextual analysis, data aggregation that includes: performing the data analytics in accordance with the identified at least one intent, and mapping the identified one or more dimensions to relevant financial data by retrieving the financial database.

Example 10 is a system of any example herein, particularly example 8, further including receiving a contextual query that is based at least in part on the financial query, including one or more parameters and an intent, wherein a parameter of the one or more parameters is based at least in part on the one or more dimensions or the one or more results; and generating, via the second large language model of the one or more machine-learning techniques, a response based on the contextual query.

Example 11 is a system of any example herein, particularly example 10, wherein the intent corresponds to a request for a financial recommendation, and wherein the response includes a result comprising the financial recommendation in the natural language format.

Example 12 is a system of any example herein, particularly example 8, further including extracting a first subset of financial data from the financial data based on a first dimension of the set of dimensions, wherein the first dimension corresponds to a customer attribute of the financial data; applying the one or more machine-learning techniques that are configured to identify behavior patterns, including regular and anomalous behaviors, from the first subset of financial data, wherein the one or more machine-learning techniques are trained on historical behavior patterns associated with the first dimension; predicting a churn probability of a structured financial record of the first subset of financial data based on the identified behavior patterns; categorizing the first subset of financial data into one or more segments based on the predicted churn probability and the identified behavior patterns; and providing an interactive graphical user interface including one or more visual representations associated with the one or more segments, wherein the interactive graphical user interface displays a segment context, and the data analytics associated with a segment of the one or more segments.

Example 13 is a system of any example herein, particularly example 8, further including extracting a second subset of financial data from the financial data based on a second dimension of the set of dimensions, wherein the second dimension corresponds to an item, product or service attribute of the financial data; analyzing the second subset of financial data by applying the one or more machine-learning techniques that are configured to perform the data analytics and predictive analytics; segmenting the second subset of financial data into one or more segments based on the data analytics including sales patterns and based on the predictive analytics that leverages data analytics to forecast potential actions for a group of the one or more groups; and providing an interactive graphical user interface including one or more visual representations associated with the one or more segments, wherein the interactive graphical user interface displays a segment context, and the data analytics associated with a segment of the one or more segments.

Example 14 is a system of any example herein, particularly example 13, further including accessing a specific entity from a set of entities that is associated with a dimensional value of the set of dimensional values; and generating, via a third large language model of the one or more machine-learning techniques, a marketing message in the natural language format based on entity attributes.

Example 15 is a computer-program product tangibly embodied in a non-transitory machine-readable storage medium, including instructions configured to cause one or more data processors to perform action including accessing financial data of a business entity from a financial database, wherein the financial data comprises a plurality of structured financial records, wherein a structured financial record of the plurality of structured financial records comprises account information associated with a transaction; generating, based at least in part on the financial data, a set of dimensions by applying one or more machine-learning techniques that are configured to identify associations between a dimension of the set of dimensions and a set of relevant structured financial records, wherein the dimension of the set of dimensions corresponds to a distinct attribute of the financial data linked to the account information; mapping automatically a set of dimensional values by accessing the set of relevant structured financial records to the dimension of the set of dimensions; dynamically generating a dimensional context associated with the dimension of the set of dimensions by applying a first large language model of the one or more machine-learning techniques, wherein the dimensional context corresponds to an interpretation of the dimension in a natural language format; receiving, via an interactive user interface, a financial query in the natural language format comprising at least one intent to be performed on the financial data based on one or more dimensions of the set of dimensions, wherein the at least one intent corresponds to an action; dynamically generating, based on the financial query, a financial report that corresponds to a dimension of the one or more dimensions by performing data analytics, wherein the financial report includes one or more financial metrics for the financial data that is filtered and categorized based on the dimension of the one or more dimensions; and generating, based at least in part on the financial report, the dimensional context, and the financial query, a formatted response including at least one result that corresponds to the at least one intent from the financial query in the natural language format by deploying a second large language model of the one or more machine-learning techniques, wherein the at least one result includes the data analytics involving the one or more financial metrics and the one or more dimensions.

Example 16 is a computer-program product of any example herein, particularly example 15, further including performing a query interpretation to identify the at least one intent and one or more data entities from the financial query, wherein the one or more data entities include the one or more dimensions and the one or more financial metrics; performing a contextual analysis configured to analyze a context of the financial query and one or more dimensional contexts associated with the identified one or more dimensions; and performing, based on the contextual analysis, data aggregation that includes: performing the data analytics in accordance with the identified at least one intent, and mapping the identified one or more dimensions to relevant financial data by retrieving the financial database. Example 17 is a computer-program product of any example herein, particularly example 15, further including receiving a contextual query that is based at least in part on the financial query, including one or more parameters and an intent, wherein a parameter of the one or more parameters is based at least in part on the one or more dimensions or the at least one result; and generating, via the second large language model of the one or more machine-learning techniques, a response based on the contextual query.

Example 18 is a computer-program product of any example herein, particularly example 16, wherein the intent corresponds to a request for a financial recommendation, and wherein the response includes a result comprising the financial recommendation in the natural language format.

Example 19 is a computer-program product of any example herein, particularly example 15, further including extracting a first subset of financial data from the financial data based on a first dimension of the set of dimensions, wherein the first dimension corresponds to a customer attribute of the financial data; applying the one or more machine-learning techniques that are configured to identify behavior patterns, including regular and anomalous behaviors, from the first subset of financial data, wherein the one or more machine-learning techniques are trained on historical behavior patterns associated with the first dimension; predicting a churn probability of a structured financial record of the first subset of financial data based on the identified behavior patterns; categorizing the first subset of financial data into one or more segments based on the predicted churn probability and the identified behavior patterns; and providing an interactive graphical user interface including one or more visual representations associated with the one or more segments, wherein the interactive graphical user interface displays a segment context, and the data analytics associated with a segment of the one or more segments.

Example 20 is a computer-program product of any example herein, particularly example 15, further includes extracting a second subset of financial data from the financial data based on a second dimension of the set of dimensions, wherein the second dimension corresponds to an item, product or service attribute of the financial data; analyzing the second subset of financial data by applying the one or more machine-learning techniques that are configured to perform the data analytics and predictive analytics; segmenting the second subset of financial data into one or more segments based on the data analytics including sales patterns and based on the predictive analytics that leverages data analytics to forecast potential actions for a group of the one or more groups; and providing an interactive graphical user interface including one or more visual representations associated with the one or more segments, wherein the interactive graphical user interface displays a segment context, and the data analytics associated with a segment of the one or more segments.

Example 21 is a computer-program product of any example herein, particularly example 20, further including accessing a specific entity from a set of entities that is associated with a dimensional value of the set of dimensional values; and generating, via a third large language model of the one or more machine-learning techniques, a marketing message in the natural language format based on entity attributes.

At least one example of the present disclosure includes a system including one or more data processors. In at least one example, the system includes a non-transitory computer readable storage medium containing instruction which, when executed on the one or more data processors, cause the one or more data processors to perform part or all of one or more methods and/or part or all of one or more processes disclosed herein. At least one example of the present disclosure includes a computer-program product tangibly embodied in a non-transitory machine-readable storage medium, including instructions configured to cause one or more data processors to perform part or all of one or more methods and/or part or all of one or more processes disclosed herein.

The present description provides preferred exemplary embodiments only, and is not intended to limit the scope, applicability, or configuration of the disclosure. Rather, the present description of the preferred exemplary embodiments will provide those skilled in the art with an enabling description for implementing various embodiments. It is understood that various changes may be made in the function and arrangement of elements without departing from the spirit and scope as set forth in the appended claims.

Specific details are given in the present description to provide a thorough understanding of the examples. However, it will be understood that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the examples.

We claim:

1. A computer-implemented method comprising:
accessing financial data of a business entity from a financial database, wherein the financial data comprises a plurality of structured financial records, wherein a structured financial record of the plurality of structured financial records comprises account information associated with a transaction;
generating, based at least in part on the financial data, a set of dimensions by applying one or more machine-learning techniques that are configured to identify associations between a dimension of the set of dimensions and a set of relevant structured financial records, wherein the dimension of the set of dimensions corresponds to a distinct attribute of the financial data linked to the account information;
mapping automatically a set of dimensional values by accessing the set of relevant structured financial records to the dimension of the set of dimensions;
dynamically generating a dimensional context associated with the dimension of the set of dimensions by applying a first large language model of the one or more machine-learning techniques, wherein the dimensional context corresponds to an interpretation of the dimension in a natural language format;
receiving, via an interactive user interface, a financial query in the natural language format comprising at least one intent to be performed on the financial data based on one or more dimensions of the set of dimensions, wherein the at least one intent corresponds to an action;
dynamically generating, based on the financial query, a financial report that corresponds to a dimension of the one or more dimensions by performing data analytics, wherein the financial report includes one or more financial metrics for the financial data that is filtered and categorized based on the dimension of the one or more dimensions and the associated set of dimensional values; and
generating, based at least in part on the financial report, the dimensional context, and the financial query, a formatted response including at least one result that corresponds to the at least one intent from the financial query in the natural language format by deploying a second large language model of the one or more machine-learning techniques, wherein the at least one result includes the data analytics involving the one or more financial metrics and the one or more dimensions.

2. The computer-implemented method of claim 1, further includes:
performing a query interpretation to identify the at least one intent and one or more data entities from the financial query, wherein the one or more data entities include the one or more dimensions and the one or more financial metrics;
performing a contextual analysis configured to analyze a context of the financial query and one or more dimensional contexts associated with the one or more dimensions; and
performing, based on the contextual analysis, data aggregation that includes:
performing the data analytics in accordance with the identified at least one intent, and
mapping the one or more dimensions to relevant financial data by retrieving the financial database.

3. The computer-implemented method of claim 1, further includes:
receiving a contextual query that is based at least in part on the financial query, including one or more parameters and an intent, wherein a parameter of the one or more parameters is based at least in part on the one or more dimensions or the at least one result; and
generating, via the second large language model of the one or more machine-learning techniques, a response based on the contextual query.

4. The computer-implemented method of claim 3, wherein the intent corresponds to a request for a financial recommendation, and wherein the response includes a result comprising the financial recommendation in the natural language format.

5. The computer-implemented method of claim 1, further includes:
extracting a first subset of financial data from the financial data based on a first dimension of the set of dimensions, wherein the first dimension corresponds to a customer attribute of the financial data;
applying the one or more machine-learning techniques that are configured to identify behavior patterns, including regular and anomalous behaviors, from the first subset of financial data, wherein the one or more machine-learning techniques are trained on historical behavior patterns associated with the first dimension;
predicting a churn probability of a structured financial record of the first subset of financial data based on the identified behavior patterns;
categorizing the first subset of financial data into one or more segments based on the churn probability and the identified behavior patterns; and
providing an interactive graphical user interface including one or more visual representations associated with the one or more segments, wherein the interactive graphical user interface displays a segment context, and the data analytics associated with a segment of the one or more segments.

6. The computer-implemented method of claim 1, further includes:
extracting a second subset of financial data from the financial data based on a second dimension of the set of dimensions, wherein the second dimension corresponds to an item, product or service attribute of the financial data;
analyzing the second subset of financial data by applying the one or more machine-learning techniques that are configured to perform the data analytics and predictive analytics;
segmenting the second subset of financial data into one or more segments based on the data analytics including sales patterns and based on the predictive analytics that leverages the data analytics to forecast potential actions for a group of the one or more groups; and
providing an interactive graphical user interface including one or more visual representations associated with the one or more segments, wherein the interactive graphical user interface displays a segment context, and the data analytics associated with a segment of the one or more segments.

7. The computer-implemented method of claim 6, further includes:
accessing a specific entity from a set of entities that is associated with a dimensional value of the set of dimensional values; and
generating, via a third large language model of the one or more machine-learning techniques, a marketing message in the natural language format based on entity attributes.

8. A system comprising:
one or more data processors; and
a non-transitory computer readable storage medium containing instructions which, when executed on the one or more data processors, cause the one or more data processors to perform actions including:
access financial data of a business entity from a financial database, wherein the financial data comprises a plurality of structured financial records, wherein a structured financial record of the plurality of structured financial records comprises account information associated with a transaction;
generate, based at least in part on the financial data, a set of dimensions by applying one or more machine-learning techniques that are configured to identify associations between a dimension of the set of dimensions and a set of relevant structured financial records, wherein the dimension of the set of dimensions corresponds to a distinct attribute of the financial data linked to the account information;
automatically map a set of dimensional values by accessing the set of relevant structured financial records to the dimension of the set of dimensions;
dynamically generate a dimensional context associated with the dimension of the set of dimensions by applying a first large language model of the one or more machine-learning techniques, wherein the dimensional context corresponds to an interpretation of the dimension in a natural language format;
receive, via an interactive user interface, a financial query in the natural language format comprising at least one intent to be performed on the financial data based on one or more dimensions of the set of dimensions, wherein the at least one intent corresponds to an action;
dynamically generate, based on the financial query, a financial report that corresponds to a dimension of the one or more dimensions by performing data analytics, wherein the financial report includes one or more financial metrics for the financial data that is filtered and categorized based on the dimension of the one or more dimensions; and
generate, based at least in part on the financial report, the dimensional context, and the financial query, a formatted response including at least one result that corresponds to the at least one intent from the financial query in the natural language format by deploying a second large language model of the one or more machine-learning techniques, wherein the at least one result includes the data analytics involving the one or more financial metrics and the one or more dimensions.

9. The system of claim 8, further including:
performing a query interpretation to identify the at least one intent and one or more data entities from the financial query, wherein the one or more data entities include the one or more dimensions and the one or more financial metrics;
performing a contextual analysis configured to analyze a context of the financial query and one or more dimensional contexts associated with the one or more dimensions; and
performing, based on the contextual analysis, data aggregation that includes:
performing the data analytics in accordance with the identified at least one intent, and
mapping the one or more dimensions to relevant financial data by retrieving the financial database.

10. The system of claim 8, further including:
receiving a contextual query that is based at least in part on the financial query, including one or more parameters and an intent, wherein a parameter of the one or more parameters is based at least in part on the one or more dimensions or the at least one result; and
generating, via the second large language model of the one or more machine-learning techniques, a response based on the contextual query.

11. The system of claim 10, wherein the intent corresponds to a request for a financial recommendation, and wherein the response includes a result comprising the financial recommendation in the natural language format.

12. The system of claim 8, further including:
extracting a first subset of financial data from the financial data based on a first dimension of the set of dimensions, wherein the first dimension corresponds to a customer attribute of the financial data;
applying the one or more machine-learning techniques that are configured to identify behavior patterns, including regular and anomalous behaviors, from the first subset of financial data, wherein the one or more machine-learning techniques are trained on historical behavior patterns associated with the first dimension;
predicting a churn probability of a structured financial record of the first subset of financial data based on the identified behavior patterns;
categorizing the first subset of financial data into one or more segments based on the churn probability and the identified behavior patterns; and
providing an interactive graphical user interface including one or more visual representations associated with the one or more segments, wherein the interactive graphical user interface displays a segment context, and the data analytics associated with a segment of the one or more segments.

13. The system of claim 8, further including:
extracting a second subset of financial data from the financial data based on a second dimension of the set of dimensions, wherein the second dimension corresponds to an item, product, or service attribute of the financial data;
analyzing the second subset of financial data by applying the one or more machine-learning techniques that are configured to perform the data analytics and predictive analytics;
segmenting the second subset of financial data into one or more segments based on the data analytics including sales patterns and based on the predictive analytics that leverages the data analytics to forecast potential actions for a group of the one or more groups; and
providing an interactive graphical user interface including one or more visual representations associated with the one or more segments, wherein the interactive graphical user interface displays a segment context, and the data analytics associated with a segment of the one or more segments.

14. The system of claim 13, further includes:
accessing a specific entity from a set of entities that is associated with a dimensional value of the set of dimensional values; and
generating, via a third large language model of the one or more machine-learning techniques, a marketing message in the natural language format based on entity attributes.

15. A computer-program product tangibly embodied in a non-transitory machine-readable storage medium, including instructions configured to cause one or more data processors to perform action including:
accessing financial data of a business entity from a financial database, wherein the financial data comprises a plurality of structured financial records, wherein a structured financial record of the plurality of structured financial records comprises account information associated with a transaction;
generating, based at least in part on the financial data, a set of dimensions by applying one or more machine-learning techniques that are configured to identify associations between a dimension of the set of dimensions and a set of relevant structured financial records, wherein the dimension of the set of dimensions corresponds to a distinct attribute of the financial data linked to the account information;
mapping automatically a set of dimensional values by accessing the set of relevant structured financial records to the dimension of the set of dimensions;
dynamically generating a dimensional context associated with the dimension of the set of dimensions by applying a first large language model of the one or more machine-learning techniques, wherein the dimensional context corresponds to an interpretation of the dimension in a natural language format;
receiving, via an interactive user interface, a financial query in the natural language format comprising at least one intent to be performed on the financial data based on one or more dimensions of the set of dimensions, wherein the at least one intent corresponds to an action;
dynamically generating, based on the financial query, a financial report that corresponds to a dimension of the one or more dimensions by performing data analytics, wherein the financial report includes one or more financial metrics for the financial data that is filtered and categorized based on the dimension of the one or more dimensions; and
generating, based at least in part on the financial report, the dimensional context, and the financial query, a formatted response including at least one result that corresponds to the at least one intent from the financial query in the natural language format by deploying a second large language model of the one or more machine-learning techniques, wherein the at least one result includes the data analytics involving the one or more financial metrics and the one or more dimensions.

16. The computer-program product of claim 15, further includes:
performing a query interpretation to identify the at least one intent and one or more data entities from the financial query, wherein the one or more data entities include the one or more dimensions and the one or more financial metrics;
performing a contextual analysis configured to analyze a context of the financial query and one or more dimensional contexts associated with the one or more dimensions; and
performing, based on the contextual analysis, data aggregation that includes:
performing the data analytics in accordance with the identified at least one intent, and
mapping the one or more dimensions to relevant financial data by retrieving the financial database.

17. The computer-program product of claim 15, further includes:
receiving a contextual query that is based at least in part on the financial query, including one or more parameters and an intent, wherein a parameter of the one or more parameters is based at least in part on the one or more dimensions or the at least one result, and wherein the intent corresponds to a request for a financial recommendation; and
generating, via the second large language model of the one or more machine-learning techniques, a response based on the contextual query, wherein the response includes a result comprising the financial recommendation in the natural language format.

18. The computer-program product of claim 15, further includes:
extracting a first subset of financial data from the financial data based on a first dimension of the set of dimensions, wherein the first dimension corresponds to a customer attribute of the financial data;
applying the one or more machine-learning techniques that are configured to identify behavior patterns, including regular and anomalous behaviors, from the first subset of financial data, wherein the one or more machine-learning techniques are trained on historical behavior patterns associated with the first dimension;
predicting a churn probability of a structured financial record of the first subset of financial data based on the identified behavior patterns;
categorizing the first subset of financial data into one or more segments based on the churn probability and the identified behavior patterns; and
providing an interactive graphical user interface including one or more visual representations associated with the one or more segments, wherein the interactive graphical user interface displays a segment context, and the data analytics associated with a segment of the one or more segments.

19. The computer-program product of claim 15, further includes:
extracting a second subset of financial data from the financial data based on a second dimension of the set of dimensions, wherein the second dimension corresponds to an item, product, or service attribute of the financial data;
analyzing the second subset of financial data by applying the one or more machine-learning techniques that are configured to perform the data analytics and predictive analytics;
segmenting the second subset of financial data into one or more segments based on the data analytics including sales patterns and based on the predictive analytics that leverages the data analytics to forecast potential actions for a group of the one or more groups; and
providing an interactive graphical user interface including one or more visual representations associated with the one or more segments, wherein the interactive graphical user interface displays a segment context, and the data analytics associated with a segment of the one or more segments.

20. The computer-program product of claim 19, further includes:
accessing a specific entity from a set of entities that is associated with a dimensional value of the set of dimensional values; and
generating, via a third large language model of the one or more machine-learning techniques, a marketing message in the natural language format based on entity attributes.
